(19) United States
(12) Patent Application Publication
(10) Pub. No.: US 2025/0010769 A1
(43) Pub. Date: Jan. 9, 2025

(54) CHILD SEAT HARNESS TIGHTENING MECHANISM

(71) Applicant: Indiana Mills & Manufacturing, Inc., Westfield, IN (US)

(72) Inventors: Thomas M. Mashino, Kokomo, IN (US); Jeffrey Alan King, Markleville, IN (US); Jeffrey David Huck, Anderson, IN (US)

(73) Assignee: Indiana Mills & Manufacturing, Inc., Westfield, IN (US)

(21) Appl. No.: 18/896,180

(22) Filed: Sep. 25, 2024

Related U.S. Application Data
(63) Continuation of application No. PCT/US2023/065037, filed on Mar. 28, 2023.
(60) Provisional application No. 63/370,422, filed on Aug. 4, 2022.
(60) Provisional application No. 63/269,988, filed on Mar. 28, 2022.

(51) Int. Cl. B60N 2/28; B60N 2/26

(52) U.S. Cl. CPC B60N 2/2812; B60N 2/265; B60N 2/2816

(57) ABSTRACT

A method and system for securing a child or passenger. The method or system has a harness. The method or system has a cam buckle. The method or system has a harness adjuster. The method or system has a handle. The handle is operatively connected to the harness adjuster. The harness adjuster includes a one-way ratchet. The harness passes through the belt adjuster and the cam buckle. The handle is configured to activate the tightening mechanism to tighten the harness to a set tension through a single actuation motion.

### CROSS REFERENCE TO RELATED APPLICATIONS

This application is a continuation of International Patent Application Number PCT/US2023/065037, filed Mar. 28, 2023, which is hereby incorporated by reference. International Patent Application Number PCT/US2023/065037, filed Mar. 28, 2023, claims the benefit of U.S. Patent Application No. 63/370,422, filed Aug. 4, 2022, which are hereby incorporated by reference. International Patent Application Number PCT/US2023/065037, filed Mar. 28, 2023, claims the benefit of U.S. Patent Application No. 63/269,988, filed Mar. 28, 2022, which are hereby incorporated by reference.

### BACKGROUND

Child safety seats are commonly used to secure and protect children in a variety of vehicles. Various harness configurations can be used to safely and comfortably secure a child. However, it can be cumbersome and tedious to properly configure the harness, to adjust the harness, or to release the harness. Often times it is difficult to know when the harness is properly tightened and secured.

Thus, there is a need for improvement in this field.

### SUMMARY

Children are often not properly secured in a child seat. The harness of the child seat is often secured too loose or too tight. A safety restraint or harness system has been developed for securing a child using a single adjustment mechanism. The method for securing the child helps ensure that the belt is properly tensioned. The system is configured to secure a passenger with proper tension in the belt system by removing slack from the system to achieve a set tension.

An actuator such as a handle is used to release and tighten the mechanism. The handle is pulled completely up to release a cam buckle such as an A-LOK®. Releasing the cam buckle allows the webbing to be extracted freely. Once the handle is released, the cam buckle closes and keeps the slack in the harness. Once the child or passenger is in the seat and fastened into the harness, the handle is again lifted to the activation position to remove slack from the webbing of the harness. A tightening mechanism such as a spring is mounted to the mechanism frame and a spool is used to remove slack. After removing slack from the webbing, the handle is pushed completely down into another position to manually tighten the harness. A ratchet pawl engages with the spool. Once proper tension is achieved in the harness, the ratchet pawl acts as a clutching device and skips teeth on the spool to prevent over-tightening.

In other examples, the mechanism uses a knob that is rotated to allow slack to be pulled out of the system. The user applies force and twists the knob to release the cam buckle or A-LOK®. Releasing the knob puts the system back into a locked state with the harness remaining extracted. Once the child is buckled into the harness, the knob is pulled outward. A string or cord is functionally attached to the knob. Pulling the knob outward tightens the harness. The string cord functions much like the starter of a lawn mower. A clutch is in place in the system that prevents the harness from being overtightened and produces audible clicking sound when this is achieved. The purpose of the push-twist mechanism is to prevent a child or unwanted user from unlocking the system during use.

Traditional methods often require manually tensioning the harness. Instead of requiring complete manual tensioning of a belt system, the restraint tensioning system acts to begin removing slack from the system once the system is activated. The safety restraint system is constructed to begin removing slack from the harness once the system is activated. The safety restraint harness also ceases to remove slack when proper tension is achieved. In other words, the safety restraint system tensions the belt system and then stops tensioning once the harness is properly tightened. This permits the user to achieve proper tensioning without having to worry about manually securing the system. The safety restraint system also allows the user to not worry about over or under-tightening the harness because these aspects are facilitated by the system. The safety restraint system also includes features for locking the harness and/or preventing child tampering with the system once it is locked in place. One such feature includes a one-way ratchet that allows the system to tighten the harness but prevents the harness from loosening when the system is active or locked. Another such aspect is a push-twist knob that prevents child tampering.

The system and techniques as described and illustrated herein concern a number of unique and inventive aspects. Some, but by no means all, of these unique aspects are summarized below.

Aspect 1 generally concerns a system.

Aspect 2 generally concerns the system of any previous aspect including a child safety seat.

Aspect 3 generally concerns the system of any previous aspect including a safety restraint system.

Aspect 4 generally concerns the system of any previous aspect including a harness.

Aspect 5 generally concerns the system of any previous aspect including a harness adjuster.

Aspect 6 generally concerns the system of any previous aspect including a cam buckle.

Aspect 7 generally concerns the system of any previous aspect including a harness adjuster strap.

Aspect 8 generally concerns the system of any previous aspect including a actuator.

Aspect 9 generally concerns the system of any previous aspect including a lever.

Aspect 10 generally concerns the system of any previous aspect including one or more levers.

Aspect 11 generally concerns the system of any previous aspect including a connecting arm operatively connecting the harness adjuster to the levers.

Aspect 12 generally concerns the system of any previous aspect in which the actuator includes a handle.

Aspect 13 generally concerns the system of any previous aspect in which the child safety seat has a seat bottom.

Aspect 14 generally concerns the system of any previous aspect in which the handle is located at a central location on the seat bottom.

Aspect 15 generally concerns the system of any previous aspect in which the actuator includes a knob.

Aspect 16 generally concerns the system of any previous aspect in which the knob is disposed along a lateral side of the child safety seat.

Aspect 17 generally concerns the system of any previous aspect in which the actuator includes a lever.

Aspect 18 generally concerns the system of any previous aspect in which the lever is disposed along a lateral side of the child safety seat.

Aspect 19 generally concerns the system of any previous aspect in which the harness adjuster includes an actuator.

Aspect 20 generally concerns the system of any previous aspect in which the harness adjuster strap is threaded through the cam buckle.

Aspect 21 generally concerns the system of any previous aspect in which the cam buckle has an unlocked position where the harness adjuster strap is able to slide through the cam buckle.

Aspect 22 generally concerns the system of any previous aspect in which the cam buckle has a locked position where the harness adjuster strap is locked to the cam buckle.

Aspect 23 generally concerns the system of any previous aspect in which the actuator is configured to engage the cam buckle to move the cam buckle to the unlocked position to release the harness adjuster strap.

Aspect 24 generally concerns the system of any previous aspect in which the actuator is configured to disengage from the cam buckle to allow the cam buckle to return to the locked position to secure the harness adjuster strap.

Aspect 25 generally concerns the system of any previous aspect in which the cam buckle is biased towards the locked position.

Aspect 26 generally concerns the system of any previous aspect in which the cam buckle has a frame and a cam pivotally coupled to the frame to engage the harness strap.

Aspect 27 generally concerns the system of any previous aspect including push-twist activation.

Aspect 28 generally concerns the system of any previous aspect in which the cam is biased towards the locked position.

Aspect 29 generally concerns the system of any previous aspect in which the cam spring configured to bias the cam towards the locked position.

Aspect 30 generally concerns the system of any previous aspect including a retractor.

Aspect 31 generally concerns the system of any previous aspect in which the harness adjuster includes a retractor.

Aspect 32 generally concerns the system of any previous aspect in which the retractor is configured to spool the harness adjuster strap.

Aspect 33 generally concerns the system of any previous aspect in which the retractor is biased to pull the harness adjuster strap into the retractor.

Aspect 34 generally concerns the system of any previous aspect in which the retractor includes a spool around which the harness adjuster strap is wrapped.

Aspect 35 generally concerns the system of any previous aspect in which the spool is spring biased to wrap the harness adjuster strap around the spool.

Aspect 36 generally concerns the system of any previous aspect in which the retractor includes a spring configured to bias the spool to wrap the harness adjuster strap.

Aspect 37 generally concerns the system of any previous aspect in which the retractor is a locking type retractor.

Aspect 38 generally concerns the system of any previous aspect in which the retractor is a ratchet strap type retractor.

Aspect 39 generally concerns the system of any previous aspect in which the spool has one or more gears with teeth.

Aspect 40 generally concerns the system of any previous aspect in which the teeth are rounded to facilitate slippage.

Aspect 41 generally concerns the system of any previous aspect including a ratchet.

Aspect 42 generally concerns the system of any previous aspect in which the harness adjuster includes a ratchet.

Aspect 43 generally concerns the system of any previous aspect in which the ratchet includes a pawl configured to engage the teeth of the spool.

Aspect 44 generally concerns the system of any previous aspect in which the pawl is configured to pivot to engage the teeth of the spool to rotate the spool for further retraction the harness adjuster strap.

Aspect 45 generally concerns the system of any previous aspect in which the spool housing.

Aspect 46 generally concerns the system of any previous aspect in which the cam buckle when in the locked position is configured to allow the retractor to pull the harness adjuster strap into the retractor.

Aspect 47 generally concerns the system of any previous aspect in which the cam buckle when in the locked position is configured to inhibit the harness adjuster strap from being pulled from the retractor.

Aspect 48 generally concerns the system of any previous aspect in which the cam buckle when in the locked position is configured to inhibit loosening of the harness.

Aspect 49 generally concerns the system of any previous aspect in which the spool is configured to store a harness adjuster strap.

Aspect 50 generally concerns the system of any previous aspect in which the pawl is configured to slip from the teeth when a set force is applied.

Aspect 51 generally concerns the system of any previous aspect in which the pawl is configured to engage the teeth of the spool to inhibit rotation of the spool in at least one direction.

Aspect 52 generally concerns the system of any previous aspect in which the pawl is configured to pivot to disengage from the teeth of the spool to allow the spool to rotate retract the harness adjuster strap into the retractor.

Aspect 53 generally concerns the system of any previous aspect in which the pawl is configured to disengage from the teeth of the spool to allow rotation of the spool for tightening the harness.

Aspect 54 generally concerns the system of any previous aspect in which a tightening mechanism is operatively connected to the spool.

Aspect 55 generally concerns the system of any previous aspect in which the tightening mechanism is configured to rotate the spool.

Aspect 56 generally concerns the system of any previous aspect in which the pawl is configured to engage the teeth of the spool to rotate the spool for tightening the harness.

Aspect 57 generally concerns the system of any previous aspect in which the actuator is configured to move the cam buckle to the unlocked position and disengage the pawl from the teeth of the spool to retract the harness adjuster strap into the retractor.

Aspect 58 generally concerns the system of any previous aspect in which the harness adjuster strap is configured to be pulled from and retract back inside the retractor.

Aspect 59 generally concerns the system of any previous aspect in which the actuator is configured to move the cam buckle to the locked position and engage the pawl with the teeth of the spool to further retract the harness adjuster strap into the retractor.

Aspect 60 generally concerns the system of any previous aspect in which the harness adjuster strap is coupled to the harness.

Aspect 61 generally concerns the system of any previous aspect including a splitter plate connecting the harness adjuster strap to the harness.

Aspect 62 generally concerns the system of any previous aspect in which the harness adjuster strap passes through the harness adjuster and the cam buckle.

Aspect 63 generally concerns the system of any previous aspect in which the harness adjuster includes a tightening mechanism.

Aspect 64 generally concerns the system of any previous aspect in which the harness adjuster configured to tighten a harness adjuster strap.

Aspect 65 generally concerns the system of any previous aspect including a tightening mechanism.

Aspect 66 generally concerns the system of any previous aspect including a handle.

Aspect 67 generally concerns the system of any previous aspect including a spool.

Aspect 68 generally concerns the system of any previous aspect in which the handle is configured to activate the tightening mechanism to tighten the harness to a set tension through a single actuation motion.

Aspect 69 generally concerns the system of any previous aspect including a one-way ratchet.

Aspect 70 generally concerns the system of any previous aspect in which the handle is a lever.

Aspect 71 generally concerns the system of any previous aspect including a connecting arm.

Aspect 72 generally concerns the system of any previous aspect in which the push-twist activation requires a force in more than one plane to activate.

Aspect 73 generally concerns the system of any previous aspect including a cam shaft.

Aspect 74 generally concerns the system of any previous aspect including a cam pin coupled to the connecting arm.

Aspect 75 generally concerns the system of any previous aspect in which the handle includes a knob.

Aspect 76 generally concerns the system of any previous aspect including coiling at least a portion of the harness adjuster strap around a spool.

Aspect 77 generally concerns the system of any previous aspect including a cord.

Aspect 78 generally concerns the system of any previous aspect in which the handle includes a knob configured to rotate.

Aspect 79 generally concerns the system of any previous aspect in which the knob is configured to facilitate push-twist activation.

Aspect 80 generally concerns the system of any previous aspect in which the handle is operatively connected to the harness adjuster.

Aspect 81 generally concerns the system of any previous aspect in which actuating the actuator to cause tension to be removed from the harness adjuster strap to a set tension.

Aspect 82 generally concerns the system of any previous aspect in which the harness adjuster includes a one-way ratchet.

Aspect 83 generally concerns the system of any previous aspect including a clutch.

Aspect 84 generally concerns the system of any previous aspect in which the locking the harness adjuster strap in place when the actuator is not actuated.

Aspect 85 generally concerns the system of any previous aspect including a slip clutch.

Aspect 86 generally concerns the system of any previous aspect in which the clutch prevents further tightening after a set tension is reached.

Aspect 87 generally concerns the system of any previous aspect including a spring.

Aspect 88 generally concerns the system of any previous aspect in which the tightening mechanism includes an item capable of applying mechanical energy.

Aspect 89 generally concerns the system of any previous aspect in which the tightening mechanism includes a spring.

Aspect 90 generally concerns the system of any previous aspect in which the activation of the handle causes the tightening mechanism to apply mechanical energy to the spool.

Aspect 91 generally concerns the system of any previous aspect in which the tightening mechanism includes a cord.

Aspect 92 generally concerns the system of any previous aspect in which the cord is attached to the connecting arm.

Aspect 93 generally concerns the system of any previous aspect in which the rotating the lever pulls the cord.

Aspect 94 generally concerns the system of any previous aspect in which the pulling the cord releases stored potential energy onto the spool.

Aspect 95 generally concerns the system of any previous aspect in which the tightening mechanism includes a clutch.

Aspect 96 generally concerns the system of any previous aspect in which the tightening mechanism includes a one-way ratchet.

Aspect 97 generally concerns a method.

Aspect 98 generally concerns the method of any previous aspect including rotating the lever causes the connecting arm and cam pin to rotate.

Aspect 99 generally concerns the method of any previous aspect in which the rotating the lever causes the cam pin to contact the cam buckle.

Aspect 100 generally concerns the method of any previous aspect including rotating a spool to cause slack to be removed from a harness.

Aspect 101 generally concerns the method of any previous aspect including moving an actuator to cause a tightening mechanism to apply mechanical energy to the spool.

Aspect 102 generally concerns the method of any previous aspect including loosening a harness.

Aspect 103 generally concerns the method of any previous aspect including loosening a harness coupled to a harness adjuster strap threaded through a cam buckle and spooled around a retractor.

Aspect 104 generally concerns the method of any previous aspect in which the loosening the harness includes actuating an actuator to cause the cam buckle to release the harness adjuster strap.

Aspect 105 generally concerns the method of any previous aspect in which the loosening the harness includes pulling the harness.

Aspect 106 generally concerns the method of any previous aspect including tightening the harness with the retractor.

Aspect 107 generally concerns the method of any previous aspect including connecting the splitter plate to a harness adjuster strap.

Aspect 108 generally concerns the method of any previous aspect including passing the harness adjuster strap through a cam buckle.

Aspect 109 generally concerns the method of any previous aspect including passing the harness adjuster strap through a harness adjuster.

Aspect 110 generally concerns the method of any previous aspect including locking the harness with a pawl.

Aspect 111 generally concerns the method of any previous aspect including connecting the harness to a splitter plate.

Aspect 112 generally concerns a method of operating the system of any previous aspect.

Further forms, objects, features, aspects, benefits, advantages, and embodiments of the present invention will become apparent from a detailed description and drawings provided herewith.

### BRIEF DESCRIPTION OF THE DRAWINGS

FIG. 1 is a perspective view of a child safety seat according to one example.

FIG. 2 is a cross-sectional view of the FIG. 1 child safety seat.

FIG. 3 is a perspective view of a handle harness adjuster according to one example.

FIG. 4 is a partial cross-sectional view of the handle harness adjuster of FIG. 3.

FIG. 5 is a partial cross-sectional view of the handle harness adjuster of FIG. 3.

FIG. 6 is a partial cross-sectional view of the handle harness adjuster according to one example.

FIG. 7 is a perspective view of a retractor according to one example.

FIG. 8 is a top perspective view of the retractor of FIG. 7.

FIG. 9 is a partial cross-sectional view of the retractor of FIG. 7.

FIG. 10 is a partial cross-sectional view of the retractor of FIG. 7.

FIG. 11 is a partial cross-sectional view of the retractor of FIG. 7.

FIG. 12 is a partial cross-sectional view of the handle harness adjuster of FIG. 3.

FIG. 13 is a top exploded view of the retractor of FIG. 7.

FIG. 14 is a top perspective view of the retractor of FIG. 7.

FIG. 15 is a perspective view of a head support according to one example.

FIG. 16 is a side perspective view of the head support according to one example.

FIG. 17 is a perspective view of a child safety seat according to another example.

FIG. 18 is a partial cross-sectional view of the child safety seat of FIG. 17.

FIG. 19 is a perspective view of a shaft of the child safety seat of FIG. 17.

FIG. 20 is a perspective view of a handle harness adjuster according to another example.

FIG. 21 is a partial cross-sectional view of the child safety seat of FIG. 17.

FIG. 22 is a perspective view of the handle harness adjuster of FIG. 20.

FIG. 23 is a perspective view of the handle harness adjuster of FIG. 20.

FIG. 24 is a perspective view of the handle harness adjuster of FIG. 20.

FIG. 25 is a perspective view of a child safety seat according to one example.

FIG. 26 is a perspective view of a handle harness adjuster of FIG. 25.

FIG. 27 is a partial cross-sectional view of the child safety seat of FIG. 25.

FIG. 28 is a partial cross-sectional view of the child safety seat of FIG. 25.

FIG. 29 is an enlarged end view of a lever harness adjuster according to one example.

FIG. 30 is a bottom perspective view of the handle harness adjuster of FIG. 25.

FIG. 31 is an exploded perspective view of the lever harness adjuster in FIG. 25.

### DETAILED DESCRIPTION OF SELECTED EMBODIMENTS

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

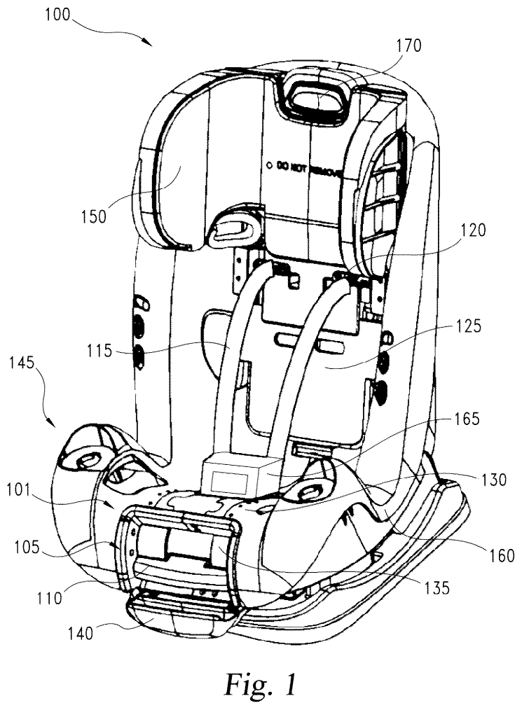

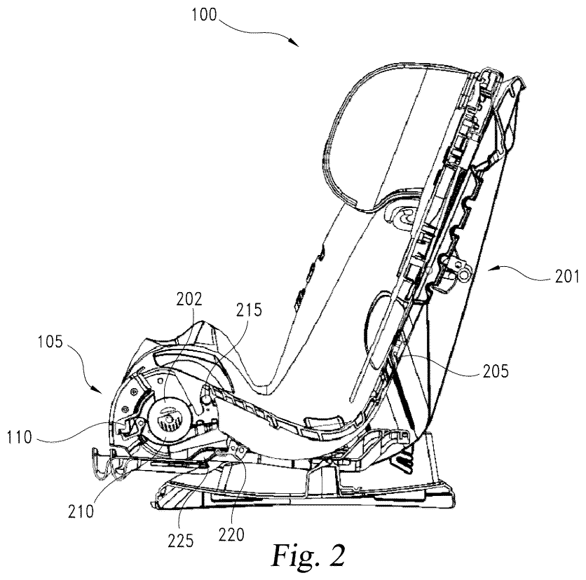

The reference numerals in the following description have been organized to aid the reader in quickly identifying the drawings where various components are first shown. In particular, the drawing in which an element first appears is typically indicated by the left-most digit(s) in the corresponding reference number. For example, an element identified by a “100” series reference numeral will likely first appear in FIG. 1, an element identified by a “200” series reference numeral will likely first appear in FIG. 2, and so on.

FIG. 1 shows a child safety seat 100 that includes a harness adjuster. Generally, the child safety seat 100 is used to secure a seat occupant such as a child or other passenger when in a vehicle using a harness adjuster 101. In the illustrated example, the harness adjuster 101 is a handle harness adjuster 105. The handle harness adjuster 105 has a handle 110 that is used to access and/or activate the handle harness adjuster 105. As will be explained further below, the handle harness adjuster 105 operates in a fashion similar to a retractable ratchet strap. The handle harness adjuster 105 is activated by using a single feature, the handle 110. In this example, the handle 110 is in the form of a T-handle. The handle 110 is configured to move into more than one position in order to control the function of the handle harness adjuster 105. The handle 110 begins in a first position or locked position in which the system is not activated. The handle 110 is then pulled or pushed into a second position or activation position. Pulling or pushing the handle 110 into the activation positions causes the handle harness adjuster 105 to begin actively securing a passenger by removing slack from the system. The handle 110 is then placed in a third position or ratcheting position which helps lock the system in place. The handle 110 is then returned to the first or locked position.

In FIG. 1, the handle harness adjuster 105 is recessed within the child safety seat 100. When the handle harness adjuster 105 is recessed within the child safety seat 100, the surface of the handle harness adjuster 105 sits flush with the surface of the child safety seat 100 such that the combination of the passenger-facing surface of the child safety seat 100 and the passenger-facing surface of the handle harness adjuster 105 form the seat of the child safety seat 100. When at least one edge of the handle harness adjuster 105 sits flush with the surface of the child safety seat 100, the configuration creates a smooth surface to facilitate comfortable seating upon the child safety seat 100. In other configurations, the handle harness adjuster 105 is partially or fully outside of the child safety seat 100.

The child safety seat 100 has a harness 115 includes a buckle 116 and a belt 117. The harness 115 is configured to act as a seat belt or a safety restraint. In some configurations, the harness 115 is a Five-Point Harness. In some configurations, the harness 115 is a positive lock. The buckle 116 is used for fastening the harness 115. The buckle 116 is generally located between the legs of the passenger. This allows the buckle 116 to be easily accessed when a passenger is seated within the child safety seat 100. This also allows multiple points of the harness 115 to converge and connect to the buckle 116 in a central location. The child safety seat 100 has a harness slot 120. In FIG. 1, the child safety seat 100 has more than one harness slot 120. The harness slot 120 is configured to house the harness 115 in the system in order to tighten the system. The harness 115 is pulled through the harness slots 120 as the handle harness adjuster 105 removes slack and adjusts the tension in the system. The harness 115 is further connected to a splitter plate which is operatively connected to the handle harness adjuster 105 by a harness adjuster strap.

The child safety seat 100 has a seatback 125 configured to support the back or spine of a passenger when the passenger is seated within the child safety seat 100. Placing more than one harness slot 120 on the seatback 125 allows the harness 115 to be placed over the shoulders of a passenger when a passenger is secured in the child safety seat 100. The child safety seat 100 also has a seat bottom 130. The seat bottom 130 is configured to support the weight of a passenger when a passenger is seated within the child safety seat 100. The handle harness adjuster 105 is located within the seat bottom 130. The handle harness adjuster 105 is accessed via the same plane that a passenger would be facing when seated within the child safety seat 100. This allows ease of access to the handle 110 of the handle harness adjuster 105 whether or not a passenger is seated upon the child safety seat 100. The handle harness adjuster 105 is generally located toward the middle of the seat bottom 130 of the child safety seat 100. This allows the handle harness adjuster 105 to be accessed between the legs of a passenger while a passenger is seated within the child safety seat 100. This configuration allows the handle 110 of the handle harness adjuster 105 to be easily accessed by either the passenger or a person securing the passenger.

The handle harness adjuster 105 is configured to include an activation space 135 which may include a contour of empty space on either side of the handle 110. In the embodiment shown in FIG. 1, the handle 110 has the activation space 135 on both sides of the handle 110 when the handle 110 is in the first position. The handle 110 beings in a first position or a locked position. In order to activate the handle harness adjuster 105 such that the handle harness adjuster 105 begins tightening the tension in the system, the handle 110 is pulled in one direction into a second position or activated position. The presence of the activation space 135 allows the handle 110 to move into the second position. In the depicted example, FIG. 1 shows the handle 110 that is moved toward the seatback 125 as the handle 110 is placed into the second position. In particular, the handle 110 is pulled toward the seat occupant in FIG. 1 when being placed in the second position or activated position. Placing the handle 110 in the second position causes the handle harness adjuster 105 to begin securing the passenger within the system. When the handle 110 is pulled up into the second position, the activation space 135 below the handle 110 increases. When the handle harness adjuster 105 has tightened the harness 115 in the system, the handle 110 is pushed in the opposite direction toward the seat bottom 130 and the handle 110 moves through the activation space 135 into a third position or ratcheting position in order to further tension the system. In the third position, the handle 110 and handle harness adjuster 105 are configured to function similar to a retractable ratchet strap.

The handle harness adjuster 105 also has a leveraging protrusion 140. The leveraging protrusion 140 is gripped by a person using the system in order to gain leverage over the handle 110 in order to facilitate pushing or pulling the handle 110 into different positions. The handle harness adjuster 105 is configured such that the activation space 135 is not infinite, and provides physical barriers to prevent the handle 110 from moving too far past the respective positions. The handle harness adjuster 105 has a second position barrier 145 that prevents the handle 110 from being pushed or pulled too far when being placed in the second position. In the illustrative example provided in FIG. 1, the leveraging protrusion 140 prevents the handle 110 from moving too far past the third position. The handle harness adjuster 105 has an outer protrusion 150. The child safety seat 100 also has a head support 155 for securing the head of a passenger. The head support 155 houses the harness 115 in FIG. 1. FIG. 1 shows the child safety seat 100 to have more than one outer protrusion 150 located on either side of the handle harness adjuster 105.

The child safety seat 100 has an angled portion 160 formed within the seat bottom 130, the seatback 125, or both. In FIG. 1, the angled portion 160 is formed on the seat bottom 130 proximal to the seatback 125. The angled portion 160 forms an acute angle between at least a portion of the seat bottom 130 and the seatback 125. The angled portion 160 prevents a passenger from sliding forward in the seat, such as due to inertia when a car is breaking or accelerating.

In other configurations, the child safety seat 100 has a headrest adjuster 170 located proximate to the head of the passenger when a passenger is seated within the child safety seat 100. The handle harness adjuster 105 enables the user to tighten a child restraint and/or harness without concern of over and/or under tightening.

FIG. 2 shows a cross-sectional view of the child safety seat 100. The belts 117 of the harness 115 are connected to a splitter plate 201. The handle harness adjuster 105 has a spool housing 202 configured to house slack of a harness adjuster strap 205. The harness adjuster strap 205 is operatively connected to the splitter plate 201. Connecting the harnesses 115 to the splitter plate 201 and connecting the splitter plate 201 to the harness adjuster strap 205 allows all straps of the system to converge into one point for tightening. The handle harness adjuster 105 has a retractor 210 which acts to remove slack from the harness adjuster strap 205 when the handle 110 is engaged, to tension the system. In one example, the retractor 210 is a one-way ratchet. In some examples, the retractor 210 uses mechanical energy to tighten the harness adjuster strap 205 by removing slack from the system. In FIG. 1, the retractor 210 permits slack to be removed when the handle 110 is engaged but prevents slack from the harness adjuster strap 205 from passing the opposite way within the system. In other configurations, the harness 115 and/or the harness adjuster strap 205 run throughout the child safety seat 100.

Lifting the handle 110 into the second position causes the handle harness adjuster 105 to begin removing slack from the harness adjuster strap 205, to tighten the system. Moving the handle 110 into the second position engages the retractor 210 to begin retracting the harness adjuster strap 205. The handle harness adjuster 105 also includes a biasing pin 215 configured to facilitate removing slack from the harness adjuster strap 205 when the handle 110 is in the second position. For example, when the handle 110 is activated to the second position, the biasing pin 215 moves towards the seat bottom 130 of the child safety seat 100, causing slack to be removed from the harness adjuster strap 205 as the harness adjuster strap 205 serpentines or wraps around the biasing pin 215.

The harness adjuster strap 205 also passes through a cam buckle 220 located below the seat bottom. The cam buckle 220 is configured to retain the harness adjuster strap 205 such that the harness adjuster strap 205 is unable to tighten and/or loosen when the handle 110 is in the locked position. Said differently, the cam buckle 220 prevents a change in tension and/or length of the harness adjuster strap 205. In one example, the cam buckle 220 is configured such that the harness adjuster strap 205 can only pass in one direction when the handle 110 is activated and the retractor 210 prevents any movement when the handle 110 is in the locked position. In FIG. 2, the cam buckle 220 allows the harness adjuster strap 205 to be pulled toward the forward-facing plane of the child safety seat 100 but prevents the harness adjuster strap 205 from retracting toward the seat back of the child safety seat 100. In some configurations, the cam buckle 220 is a modified A-LOK® by Indiana Mills & Manufacturing, Inc. (IMMI). In some examples, the cam buckle 220 is held shut by a spring. In other examples, cam buckle 220 snaps open and shut and remains so until a biasing force acts upon the cam buckle 220. The harness adjuster 101 further includes a cam actuator 225 that is configured to actuate the cam buckle 220.

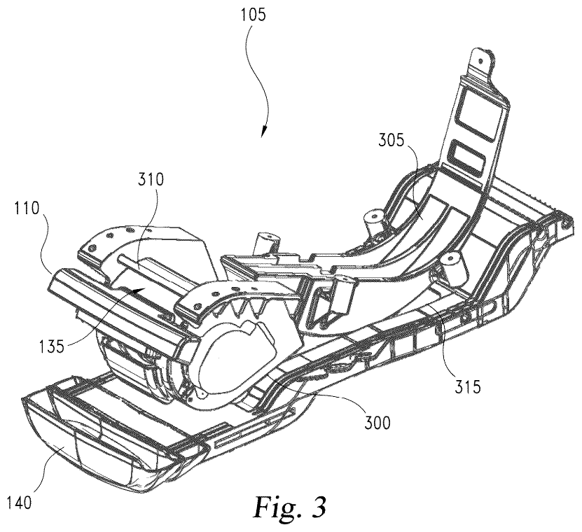

FIG. 3 shows the handle harness adjuster 105 no longer recessed within the seat. In this depiction, the retractor 210 includes a ratchet-pawl mechanism 300 that is used to cause the retractor 210 to take slack out of the harness adjuster strap 205. The ratchet-pawl mechanism 300 allows slack to be moved only one direction when the handle 110 is activated. The handle harness adjuster 105 also has a belt or webbing guide 305, which facilitates the harness adjuster strap 205 wrapping through the handle harness adjuster 105. The harness adjuster strap 205 wraps around the curved section of the handle harness adjuster 105. The curved edge of the belt or webbing guide 305 causes the harness adjuster strap 205 to wrap securely through the handle harness adjuster 105. The belt or webbing guide 305 prevents the harness adjuster strap 205 from bunching up or becoming jammed within the handle harness adjuster 105. In some embodiments, the belt or webbing guide 305 is formed to coincide with the angled portion 160 of the child safety seat 100 such that the angled portion 160 and the belt or webbing guide 305 share the same curve. The handle harness adjuster 105 also has a harness or webbing pathway 315 that allows the harness adjuster strap 205 to pass through the handle harness adjuster 105.

The handle harness adjuster 105 also has a pin 310. The pin 310 is positioned to prevent the handle 110 from being lifted too far passed the second or activated position. The handle 110 is permitted to move through the activation space 135 but is prevented from moving passed the pin 310.

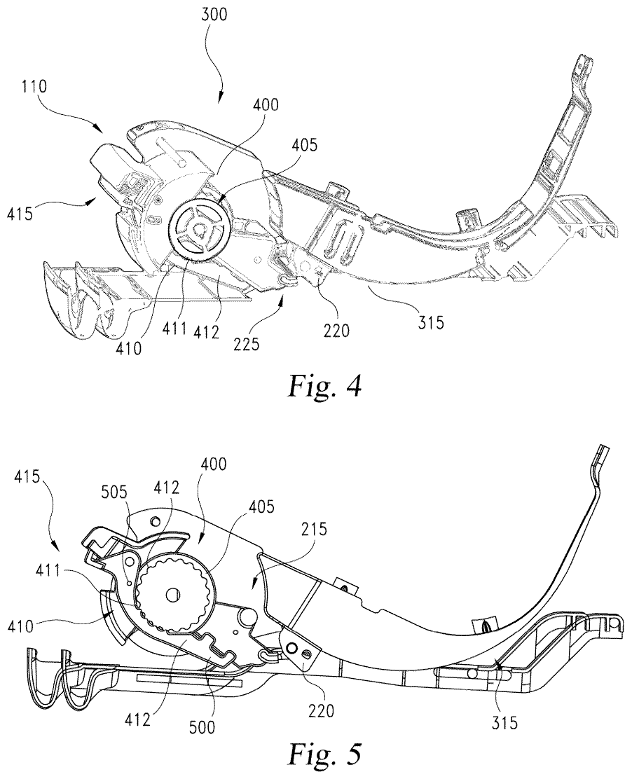

FIG. 4 shows a cross-sectional view of the handle harness adjuster 105, when the handle harness adjuster 105 is not recessed within the child safety seat 100. The ratchet-pawl mechanism 300 includes a gear 400 configured to engage with one or more gear teeth 405. The handle harness adjuster 105 also has a clutch pawl 410. The clutch pawl 410 engages the gear teeth 405 of the gear 400 by one or more clutch pawl teeth 411. The gear teeth 405 and clutch pawl 410 interact to force movement of the harness adjuster strap 205 in one direction. The clutch pawl 410 also has a smooth portion 412 on either side of the clutch pawl teeth 411. The handle harness adjuster 105 also has a spring 415 or other biasing mechanism. The spring 415 acts upon the gear 400 when the handle 110 is placed into the second position. The harness adjuster strap 205 wraps through the handle harness adjuster 105 via the harness or webbing pathway 315. The harness adjuster strap 205 wraps against the belt or webbing guide 305. When the handle 110 is actuated, the handle harness adjuster 105 begins removing slack from the system.

A further cross-sectioned view is depicted in FIG. 5. The gear 400 and gear teeth 405 are depicted in FIG. 5. The harness or webbing pathway 315 causes the ratchet-pawl mechanism 300 to rotate, the gear 400 and gear teeth 405 interact to turn the ratchet-pawl mechanism 300. The angle of the gear 400 and the gear teeth 405 are such that the gear 400 rotates clockwise in FIG. 5, but the teeth of the gear teeth 405 prevent counter-clockwise rotation. As the gear teeth 405 engages against the clutch pawl 410, the gear teeth 405 facilitates the rotation of the gear 400 in a clockwise direction in FIG. 5. The spring 415 is configured to release potential mechanical energy upon the ratchet-pawl mechanism 300 when the handle 110 is moved into the activation position. The handle harness adjuster 105 also has a pronged portion 500 which catches against the biasing pin 215 as the handle 110 is moved into the various positions. The presence of the pronged portion 500 and the biasing pin 215 prevent the handle 110 from being pushed or pulled too far.

The clutch pawl 410 is angled such that as it rotates about the axis of the gear 400, the clutch pawl teeth 411 of the clutch pawl 410 act as paws to press against the gear teeth 405 of the gear 400. This causes the gear 400 to rotate. When the clutch pawl 410 is lifted away from the gear 400 toward the second position or activated position, the clutch pawl 410 rotates about the axis of the gear 400. In FIG. 5 in particular, the clutch pawl 410 pivots around a pivot point 505 which can include a hinge, screw, or pin. As the clutch pawl 410 rotates and the relative angle amongst the clutch pawl 410 and the gear 400 changes, the clutch pawl teeth 411 will no longer engage the gear teeth 405. Instead, as the handle 110 rotates the clutch pawl 410, the smooth portion 412 of the clutch pawl 410 will engage the gear teeth 405 of the gear 400. The clutch pawl teeth 411 of the clutch pawl 410 will cease to engage the gear teeth 405 of the clutch pawl 410. When the smooth portion 412 of the clutch pawl 410 engages the gear teeth 405 of the gear 400, the smooth portion 412 slips passed the gear teeth 405 of the gear 400. When the smooth portion 412 slips passed the gear teeth 405 of the gear 400, the clutch pawl 410 will no longer cause the gear 400 to rotate. This acts as a clutch to prevent over-tightening the harness adjuster strap 205.

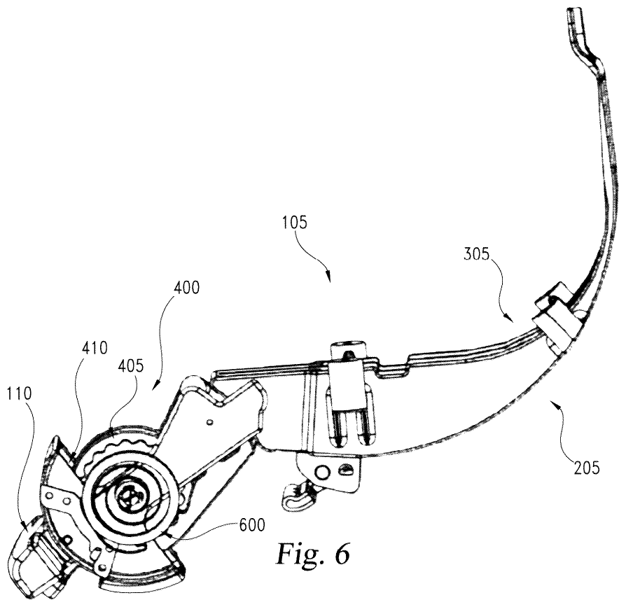

In FIG. 6, the retractor 210 includes the spring 415 or a force-applying mechanism 600. The spring 415 is configured to cause the retractor 210 to automatically begin to rotate clockwise. This causes the harness adjuster strap 205 to lose slack as the retractor 210 rotates. The harness adjuster strap 205 passes through the cam buckle 220 and into the retractor 210. As the retractor 210 rotates, the harness adjuster strap 205 wraps through and/or around the handle harness adjuster 105 such that more slack is needed. This removes slack from the system and thus tightens the harness adjuster strap 205 from the perspective of the passenger. In other examples, the harness or webbing pathway 315 is not a spring 415 but is instead another mechanism capable of storing and/or releasing mechanical energy. Once the handle 110 is lifted to activate the handle harness adjuster 105, the harness or webbing pathway 315 acts to potentiate and/or release stored potential mechanical energy, such as with a spring 415 or other force-applying mechanism 600, to begin rotating the gear 400 of the handle harness adjuster 105.

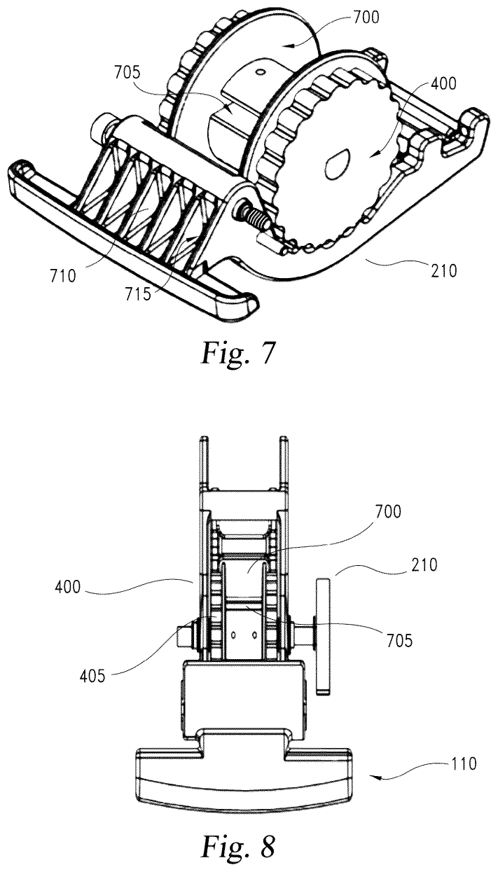

Referring to FIG. 7, the handle harness adjuster 105 includes a spool 700 which allows the harness adjuster strap 205 to wrap around and withdraws slack as the spool 700 rotates. The spool 700 is operatively connected to the force-applying mechanism 600 such that the rotation of the force-applying mechanism 600 causes rotation of the spool 700. The handle harness adjuster 105 also includes a strap passage 705 configured to allow the harness adjuster strap 205 to pass through the spool 700. This facilitates the harness adjuster strap 205 coiling around the spool 700 and helps achieve a snug tension fit.

In other configurations, the handle harness adjuster 105 includes a slip clutch. For example, the harness or webbing pathway 315 can be a force-applying mechanism 600 causing the gear 400 of the retractor 210 to rotate in a particular direction. As depicted in FIG. 7, the retractor 210 is configured to rotate counterclockwise. The gear 400 has gear teeth 405 configured to interact with the clutch pawl 410. The angles of the gear teeth 405 and the clutch pawl 410, configured toward the outside of the retractor 210 help facilitate rotational movement in one direction. The gear 400 is also configured to interact with the spool housing 202 and, in particular, the spool 700. Toward the inside of the retractor 210, the other face of the gear 400 interacts with portions of the spool 700 to cause the spool 700 to rotate as the gear 400 rotates. Rotating the spool 700 with the gear 400 causes more of the harness adjuster strap 205 to wrap around the spool 700, thus removing slack from the system and tightening the belt against the passenger. When the retractor 210 has rotated to the proper tightness, the slip clutch causes the gear teeth 405 of the gear 400 to slip past the spool 700. When the gear teeth 405 of the gear 400 slips past the strap passage 705 of the spool 700, the spool 700 no longer rotates. Thus, when the slip clutch causes the gear teeth 405 to slip past the spool 700, the retractor 210 no longer acts to remove from slack from the system.

FIG. 7 shows a rib 710. The space in between each rib 710 defines a structural spacer 715. The 710-s are constructed to provide support without adding unnecessary weight to the handle harness adjuster 105. The structural spacer 715 prevents excessive weight in the handle harness adjuster 105.

FIG. 8 depicts a top view of the retractor 210. In the illustrative example, there is a gear 400 located on either side of the spool 700. The spool 700 includes space to house the harness adjuster strap 205 as the harness adjuster strap 205 continues to coil around the spool 700.

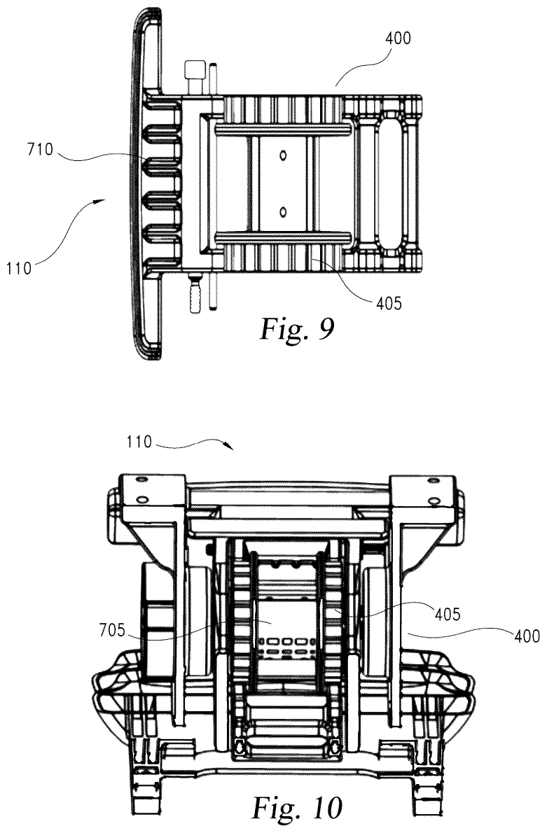

FIG. 9 shows a top view of the retractor 210, rotated at a 90-degree angle in reference to FIG. 8. The rib 710 of the handle harness adjuster 105 includes the structural spacer 715 in between each structure. The structural spacer 715 allows the handle 110 to be lighter but the rib 710 still causes a force placed upon the handle 110 to be transferred to the rest of the handle harness adjuster 105.

A cross-sectional, rear view of the retractor 210 is shown in FIG. 10. The retractor 210 includes a curved portion 1200 which causes the harness adjuster strap 205 to wrap under and facilitates the harness adjuster strap 205 entering and passing through the retractor 210. Referring to FIG. 10, the gear teeth 405 of the gear 400 can be seen to be gripping portions of the spool 700 in order to rotate the spool 700 as the gear 400 rotates. The gear 400 will continue to rotate the spool 700 until the clutch pawl teeth 411 of the clutch pawl 410 slip passed the gear teeth 405 of the gear 400. The system is configured such that the clutch pawl teeth 411 of the clutch pawl 410 will be rotated such that the clutch pawl teeth 411 slip off of the gear teeth 405 at a pre-ordained tightness of the harness adjuster strap 205 in the system. This causes the user to not have to think or manually judge when the harness adjuster strap 205 is tight enough. As the spool 700 rotates, the smooth portion of the clutch pawl 410 will be presented to the gear teeth 405 of the gear 400 and the gear teeth 405 of the gear 400 will slip past the clutch pawl teeth 411 of the clutch pawl 410, causing the spool 700 to no longer rotate.

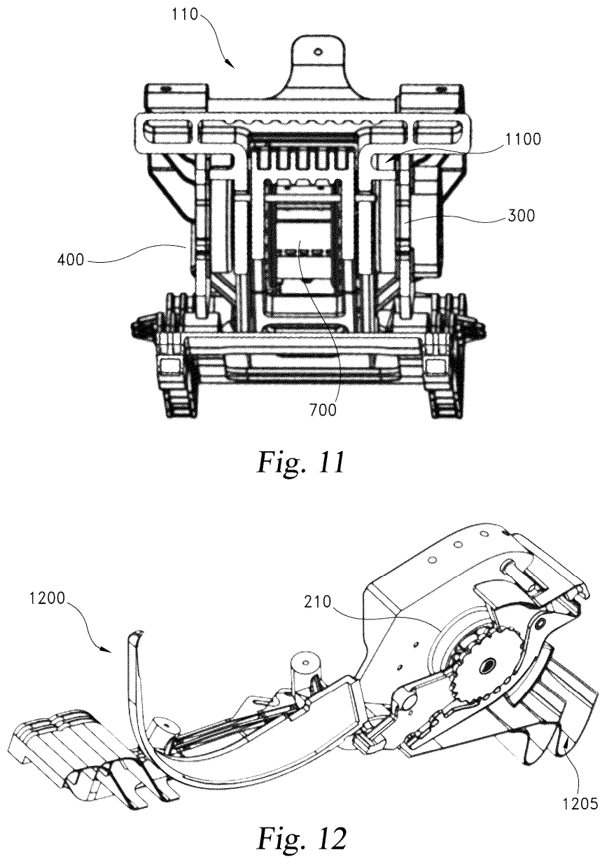

A cross-sectional, front view of the retractor 210 is depicted in FIG. 11. The spool 700 is located between two gears 400. The handle harness adjuster 105 includes a curved finger 1100. The curved finger 1100 allows the handle 110 to stay engaged to the gear 400 as the handle 110 is moved into different positions. The curved finger 1100 wraps on either side of ratchet-pawl mechanism 300. The curved finger 1100 slides and stays connected as the angle between the handle 110 and the ratchet-pawl mechanism 300 is adjusted when the handle 110 is moved into different positions. The connection of the curved finger 1100 ensures that a force placed upon the handle 110 to move the handle 110 into the respective positions is transferred to the handle harness adjuster 105, but prevents a force placed upon the handle 110 in any other direction from being transferred upon the handle harness adjuster 105.

FIG. 12 is a cross-sectional, side view of the retractor 210. The retractor 210 includes a curved portion 1200 which causes the harness adjuster strap 205 to further wrap under and facilitates the harness adjuster strap 205 entering and passing through the retractor 210. FIG. 12 shows a spaced rivet 1205 within the leveraging protrusion 140. The spaced rivet 1205 provides structural support to the leveraging protrusion 140 without adding weight.

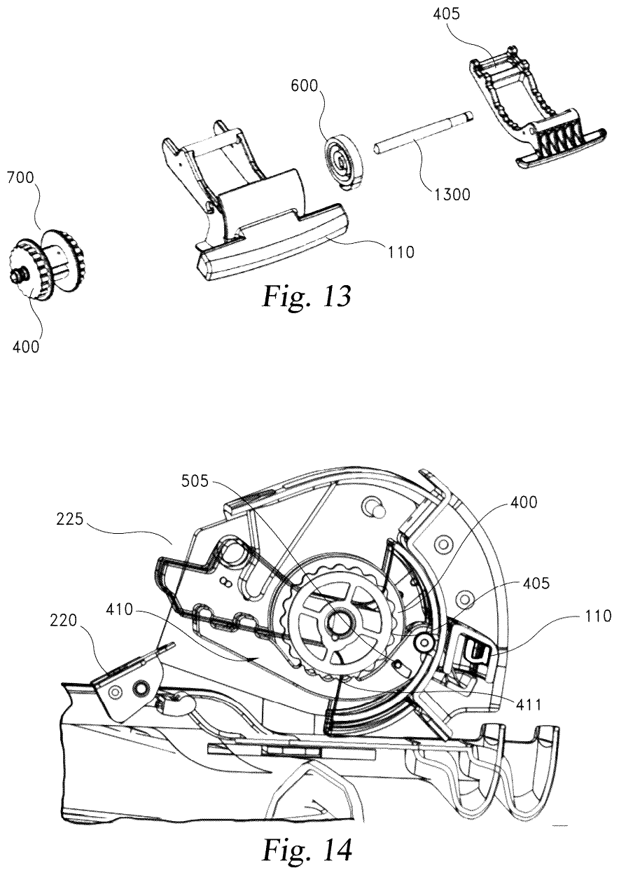

FIG. 13 is an exploded view of certain aspects of the retractor 210. FIG. 13 shows the spool 700, the handle 110, the force-applying mechanism 600 and the gear teeth 405. FIG. 13 also shows a rotate shaft 1300 which can be configured to pass through each portion of the retractor 210 in order to facilitate holding the constituent pieces together. In certain embodiments, the rotate shaft 1300 is configured to rotate with the system. In other embodiments, the rotate shaft 1300 remains stationary while constituent parts of the retractor 210 rotate about the rotate shaft 1300.

FIG. 14 shows a sectioned view of the gear teeth 405 of the gear 400. As shown, the gear teeth 405 of the gear 400 can interact with the clutch pawl 410 at one or more particular point. FIG. 14 shows the clutch pawl teeth 411 of the clutch pawl 410 interacting with the gear teeth 405 of the gear 400.

The system begins with the handle 110 in the first or locked position. The harness adjuster strap 205 runs through the cam buckle 220 and the spool 700 of the handle harness adjuster 105. The gear teeth 405 of the gear 400 interactions with the clutch pawl teeth 411 of the clutch pawl 410. The spool 700 is operatively connected to the gear 400 such that as the gear 400 rotates, the spool 700 rotates. When the handle 110 is in the locked position, the cam buckle 220 prevents the harness adjuster strap 205 from passing through. The handle 110 is actuated by being pushed or pulled into a second or activated position. As the handle 110 is lifted into the second position, the clutch pawl teeth 411 of the clutch pawl 410 act upon the gear teeth 405 of the gear 400 to cause the gear 400 to rotate, to rotate the spool 700. As the clutch pawl 410 rotates about the axis of the gear 400, the clutch pawl teeth 411 of the clutch pawl 410 will no longer engage with the gear teeth 405 of the clutch pawl 410. Instead, the smooth portion 412 of the clutch pawl 410 will slip passed the gear teeth 405 of the clutch pawl 410, preventing over-tightening. Lifting the handle 110 will additionally cause the retractor 210 or other biasing mechanism to act upon the spool 700. As the spool 700 rotates, the harness adjuster strap 205 is wrapped around the spool 700 and slack is removed from the system.

The handle 110 is then pushed all the way into the third position or ratcheting position. As the handle 110 is pushed into the third or ratcheting position. This ratchets the harness adjuster strap 205 further into place by ratcheting the harness adjuster strap 205, like a retractable ratchet strap. While the harness adjuster strap 205 is being ratcheted, the clutch pawl teeth 411 of the clutch pawl 410 is engaged with the gear teeth 405 of the gear 400. Once the smooth portion 412 of the clutch pawl 410 interacts with the gear teeth 405 of the gear 400, the clutch pawl 410 will slip passed the gear 400 and the gear 400 will no longer rotate. This functions as a clutch to prevent the harness adjuster strap 205 from being over-tightened.

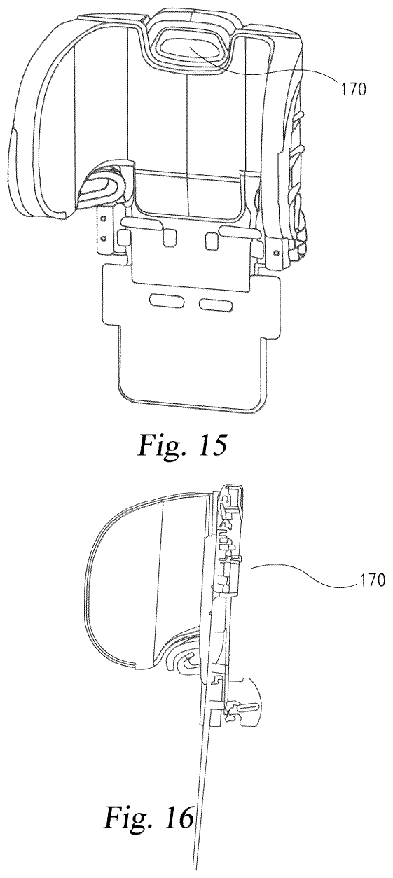

FIGS. 15 and 16 depict views of the harness 115. FIG. 15 is a perspective view of the harness 115. FIG. 16 is a cross-section, side view of the harness 115. The harness 115 is located proximate to the head of a passenger when seated within the child safety seat 100. The child safety seat 100 can include a harness 115 that works in unison with the handle 110 at the bottom of the child safety seat 100. In other embodiments, the harness 115 is the only aspect used to adjust the tightness of the harness adjuster strap 205 when the passenger is seated in the child safety seat 100.

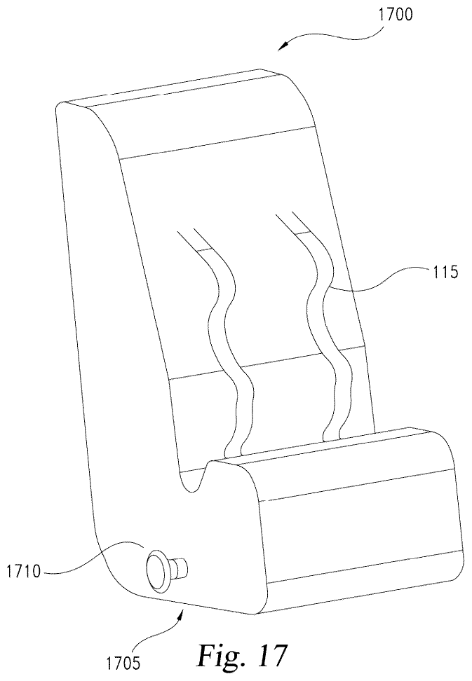

FIG. 17 shows a child safety seat 1700 in which the belt adjuster uses a knob instead of a handle. The child safety seat 1700 has a knob harness adjuster 1705 that is actuated by a knob 1710. As further explained below, the knob harness adjuster 1705 operates in a fashion similar to a child retractable ratchet strap. In this configuration, the knob harness adjuster 1705 is housed entirely within the child safety seat 100 except for the knob 1710. The knob 1710 is located on the lateral side of the child safety seat 1700 in FIG. 17. The knob harness adjuster 1705 is activated by twisting and/or pulling the knob 1710. This example does not require a linear back and forth movement of the knob 1710 in order to activate proper tightening of the cam actuator 1805 by the knob harness adjuster 1705. Instead, the knob 1710 actuates to release and pull the cam actuator 1805 via one motion. Once the knob 1710 is twisted and/or pulled, the harness adjuster strap 205 begins to tighten. In other examples, the knob 1710 requires a rotational back and forth movement to control the function of the knob harness adjuster 1705.

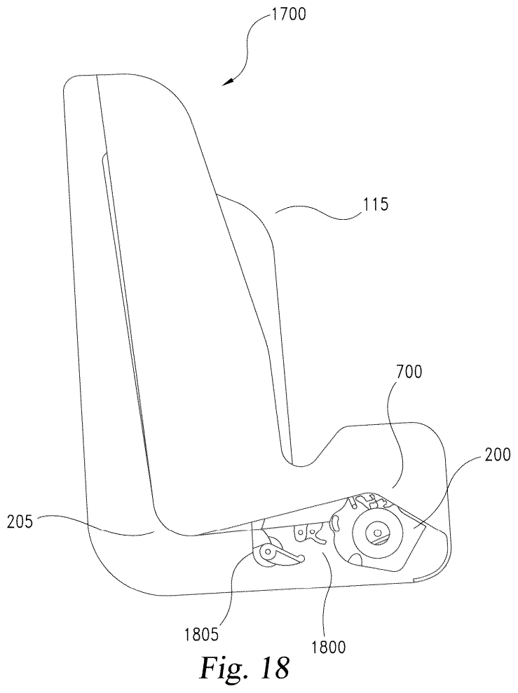

FIG. 18 shows a cam buckle 1800 configured to help control the movement of the harness adjuster strap 205 in order to adjust the tightness of the harness 115 for a passenger. The cam buckle 1800 is a one-way clip configuration that permits the harness adjuster strap 205 to pass through the cam buckle 1800 toward in one direction but not the other. In certain embodiments, the cam buckle 1800 is an A-LOK®. In this illustrative example, the cam buckle 1800 allows the harness adjuster strap 205 to be pulled in the direction of the knob harness adjuster 1705 but not the other direction when the cam buckle 1800 is locked. The child safety seat 1700 also includes a cam actuator 1805 functionally connected to the knob 1710. As the knob 1710 is rotated, the cam actuator 1805 rotates in the same direction. In FIG. 18, the cam actuator 1805 rotates counter-clockwise toward the cam buckle 1800. The cam actuator 1805 rotates to engage the cam buckle 1800 in order to free the harness adjuster strap 205 to be extracted.

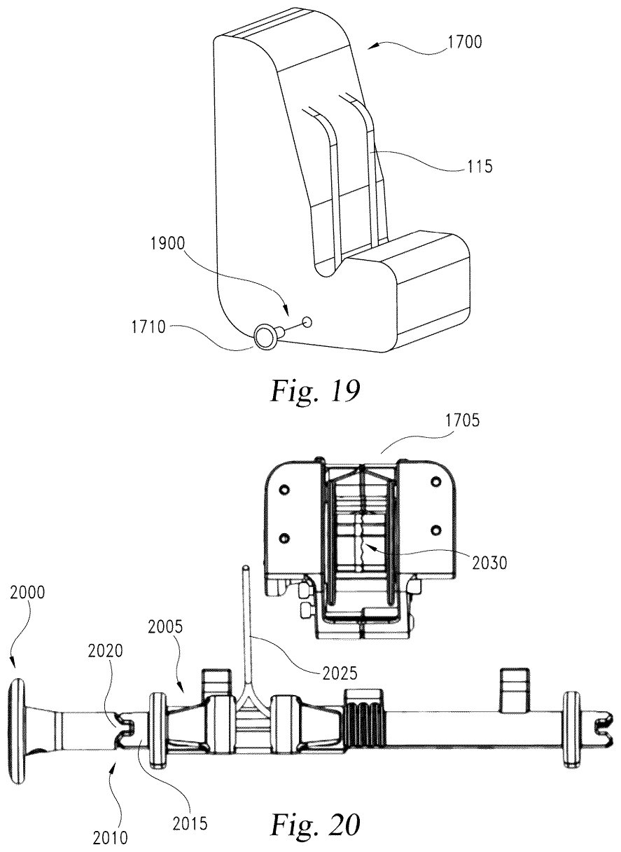

FIG. 19 shows a perspective view of the child safety seat 1700 when the knob 1710 has been engaged. The knob harness adjuster 1705 includes a shaft 1900 which protrudes and extends when the knob 1710 is pulled. Prior to the knob 1710 rotating, the shaft 1900 is stored within the child safety seat 1700. As the knob 1710 is activated, the shaft 1900 moves away from the child safety seat 1700. The shaft 1900 has a finite or fixed length and is prevented from being pulled too far or from being removed entirely from the child safety seat 1700. In this example, the shaft 1900 extends perpendicular to the child safety seat 1700. In other embodiments, the shaft 1900 can extend at different angles with respect to the child safety seat 1700 as the knob 1710 is being pulled and/or activated.

FIG. 19 shows the knob 1710 is extractable and able to be moved away from the child safety seat 1700 via the shaft 1900 as the knob 1710 is activated. As can be seen in FIG. 19, the shaft 1900 extends outward from within the child safety seat 1700. When the knob 1710 is activated, the shaft 1900 slides away from the child safety seat 1700. The cam actuator 1805 is connected to the remainder of the knob harness adjuster 1705 and aligned such that the cam actuator 1805 contacts the cam buckle 1800 as the knob 1710 rotates.

FIG. 20 is perspective view of certain aspects of the knob harness adjuster 1705 of the child safety seat 1700. The knob 1710 includes a push-twist activator 2000 that requires a simultaneous pull/twist or a simultaneous push/twist in order to activate the knob harness adjuster 1705. The shaft 1900 is connected to the knob harness adjuster 1705 by a connective arm 2005. The connective arm 2005 has a push-twist mechanism 2010 at the edge of the end connecting the push-twist activator 2000 to the connective arm 2005. The push-twist mechanism 2010 has a receiving piece 2015 and an interlocking member 2020. If only a twisting force is applied, the interlocking member 2020 does not engage the receiving piece 2015 and the push-twist activator 2000 does not rotate. When only a twisting force is placed upon the push-twist activator 2000, the push-twist mechanism 2010 prevents the push-twist activator 2000 from being able to rotate and thus the knob harness adjuster 1705 is not activated to begin removing slack from the harness adjuster strap 205. When a simultaneous twisting force and pushing force is applied to the push-twist activator 2000, the push-twist mechanism 2010 is pressed away from its original configuration and the push-twist mechanism 2010 is able to rotate, allowing the push-twist activator 2000 to be engaged. This functions much like a protective child cap on a bottle or container. In other configurations, a simultaneous twisting and pulling force is required to activate the push-twist activator 2000. Once the push-twist activator 2000 is engaged, the knob 1710 is able to move away from the child safety seat 1700 as the knob 1710 begins activating the knob harness adjuster 1705 to remove slack from the harness adjuster strap 205. Sufficient force must be applied to the push-twist activator 2000 in order to cause the push-twist mechanism 2010 to allow activation of the system. Requiring sufficient force to engage the push-twist activator 2000 prevents the push-twist activator 2000 from being easily engaged by a child or other passenger when the system is not meant to be engaged.

FIG. 20 also shows a pull cord 2025, configured to activate the knob harness adjuster 1705 once the knob 1710 is pulled. As the knob 1710 is rotated, the shaft housing 2200 is pulled in the direction away from the knob harness adjuster 1705. Pulling the first slip clutch 2205 away from the knob harness adjuster 1705 inputs energy into the system, which activates the knob harness adjuster 1705 to begin removing slack from the harness adjuster strap 205 in order to tighten the harness adjuster strap 205. The pull cord 2025 causes the spool 700 to rotate. The energy from pulling the pull cord 2025 is used to cause the retractor 210 to begin taking slack from the harness adjuster strap 205. In one example, the harness adjuster strap 205 has a recoil spring that is wound as the pull cord 2025 is pulled. When the pull cord 2025 is released, the recoil spring of the retractor 210 unwinds, causing the spool 700 to rotate. In another embodiment, the pull cord 2025 removes a biasing pin which allows the retractor 210 to release mechanical energy stored within the knob harness adjuster 1705. The knob harness adjuster 1705 further includes a second clutch 2030.

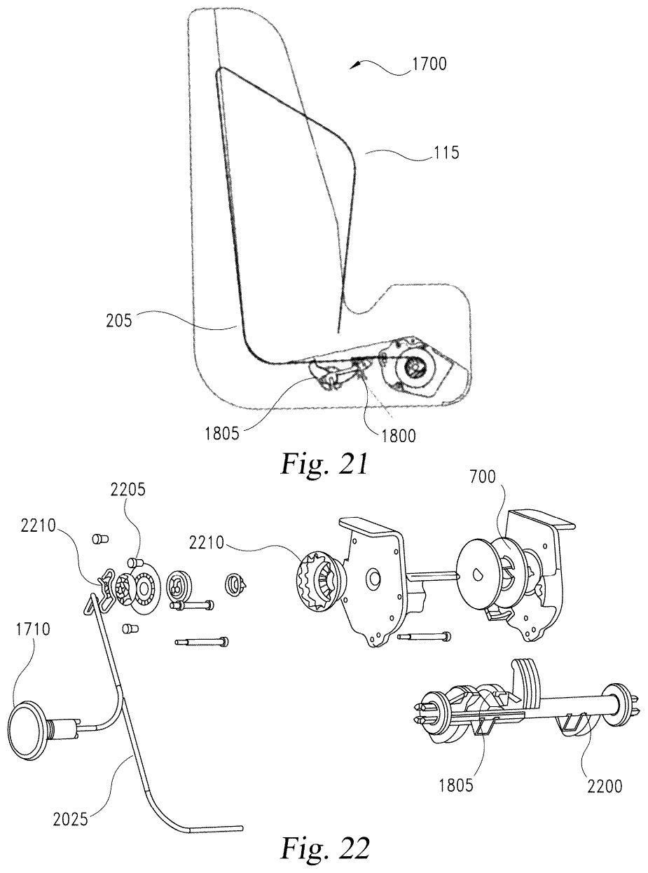

FIG. 21 depicts the cam actuator 1805 after the knob 1710 has been rotated, causing the cam actuator 1805 to rotate and engage the cam buckle 1800. In this illustrative example, the knob 1710 rotates counter-clockwise in order to engage the cam buckle 1800. Once the cam actuator 1805 engages the cam buckle 1800, the cam buckle 1800 opens and the harness adjuster strap 205 is able to move through the cam buckle 1800. As the knob 1710 continues to twist, the shaft 1900 extends from the child safety seat 1700. Pulling the shaft 1900 further inputs potential energy into the system to be used to tighten the harness adjuster strap 205.

FIG. 22 shows an exploded view of the knob harness adjuster 1705. The knob harness adjuster 1705 includes a shaft housing 2200. The shaft housing 2200 houses the shaft 1900. When the knob 1710 is activated, the shaft 1900 extends from the shaft housing 2200. As the knob 1710 rotates, the shaft housing 2200 rotates as well. The shaft housing 2200 is connected to the cam actuator 1805. As the shaft housing 2200 rotates, the cam actuator 1805 rotates. The cam actuator 1805 is positioned to contact the cam buckle 1800 as the shaft housing 2200 rotates due to the rotation of the shaft housing 2200.

The knob harness adjuster 1705 includes a first slip clutch 2205 and a second slip clutch 2210. The first slip clutch 2205 is located at the connection between the knob 1710 and the remainder of the knob harness adjuster 1705. The first slip clutch 2205 prevents the mechanism from being over-tightened by turning the knob 1710. The second slip clutch 2210 is located on the harness or webbing pathway 315. The second slip clutch 2210 prevents over-tightening by the ratchet-pawl mechanism 300.

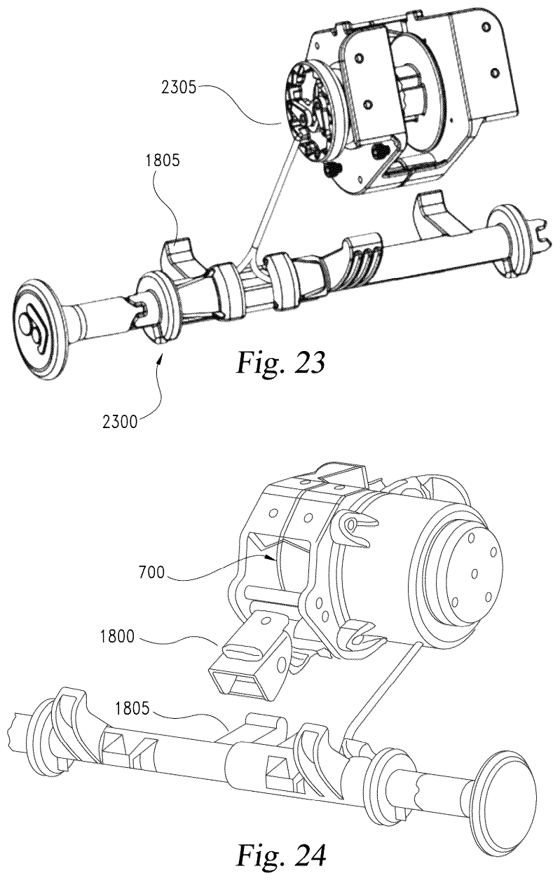

FIGS. 23 and 24 show a perspective view of an example of the knob harness adjuster 1705. The knob 1710 is operatively connected to the first slip clutch 2205. As the knob 1710 is pulled, the first slip clutch 2205 is pulled as well. The first slip clutch 2205 runs through the knob harness adjuster 1705. In this illustrative example, the first slip clutch 2205 passes through the second slip clutch 2305. Pulling the first slip clutch 2205 causes the knob harness adjuster 1705 to begin removing slack from the harness adjuster strap 205 in the system. The shaft housing 2200 includes a first slip clutch 2300 in order to prevent the knob 1710 from being rotated and/or pulled too far. The knob harness adjuster 1705 also includes a second slip clutch 2305 designed to prevent the knob harness adjuster 1705 from over-tightening the harness adjuster strap 205 by removing too much of the slack from the harness adjuster strap 205 in the system. Affixing a first slip clutch 2300 to the push-twist activator 2000 and a second slip clutch 2305 to the force-applying mechanism 600 provides a safeguard from overtightening either by the user or the force-applying mechanism 600.

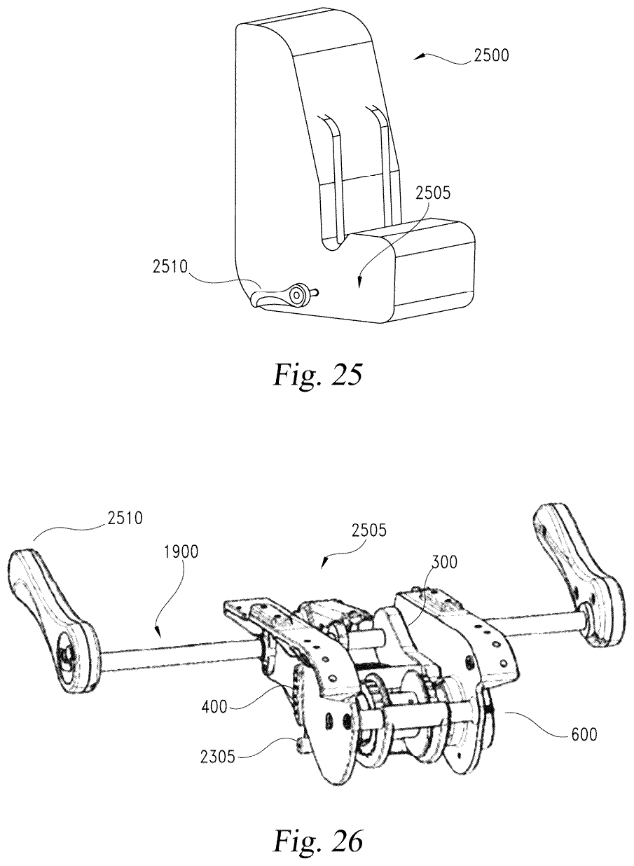

FIG. 25 depicts another configuration of a child safety seat 2500. In this illustrative example, the harness adjuster is a lever harness adjuster 2505. In this configuration, the handle 110 is a lever 2510. The lever harness adjuster 2505 is activated by rotating the lever 2510. The lever 2510 is located on the lateral plane of the child safety seat 2500. Placing the lever 2510 on the lateral plane of the child safety seat 2500 allows the lever 2510 to be accessed when a passenger is in the child safety seat 2500 and when a passenger is not in the child safety seat 2500. The lever 2510 is rotated in a first direction to activate the system to begin removing slack from the system. When the lever 2510 is no longer being rotated, the system locks. In order to loosen or release the tension in the system, the lever 2510 is rotated in a second direction. This functions much like a tape-measurer.

FIG. 26 shows an isolated front view of the knob harness adjuster 1705 used in FIG. 25. The knob harness adjuster 1705 shows the shaft 1900 connecting the lever 2510 to the remainder of the knob harness adjuster 1705. As rotational force is applied to the lever 2510, the shaft 1900 facilitates the rotational force to also be applied to the remainder of the knob harness adjuster 1705 in order to activate the knob harness adjuster 1705. The lever 2510 is rotated in the first direction to activate the tightening of the harness adjuster strap 205. The knob harness adjuster 1705 has a second slip clutch 2305 to prevent the system from being tightened too much by the force-applying mechanism 600. The knob harness adjuster 1705 also has a gear 400 which includes the gear teeth 405 to facilitate single-directional rotation.

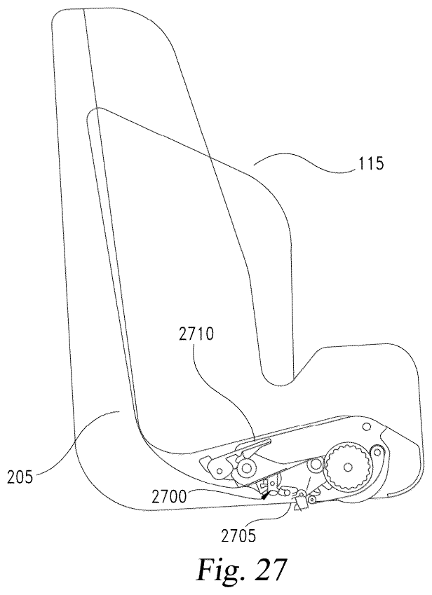

FIG. 27 shows a cross-sectional side view of the knob harness adjuster 1705. The knob harness adjuster 1705 has a cam buckle 2700 and a cam actuator 2705. The cam actuator 2705 is connected to the lever 2510. The harness adjuster strap 205 is released by rotating the lever 2510 in a first direction, in this example clockwise. When the lever 2510 is rotated in a first direction, the cam actuator 2705 rotates in the same direction. The cam actuator 2705 is shown in FIG. 27 to be in contact with the cam buckle 2700 in order to cause the cam buckle 2700 to allow harness adjuster strap 205 to pass through the cam buckle 2700. After the passenger is secured in the seat and the harness adjuster strap 205 is buckled, the lever is released and the cam buckle 1800 holds the harness adjuster strap 205 with slack. Rotating the knob 1710 in a second direction, in this example counter clockwise to take slack out of the harness adjuster strap 205. The child safety seat 1700 also has a lever locking feature 2710. The lever locking feature 2710 is located between the lever 2510 and the seatback 125. The lever locking feature 2710 locks and prevents the lever 2510 from being able to be activated by a child or other passenger.

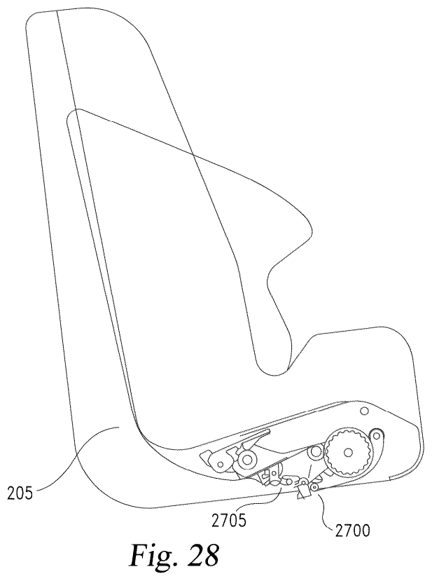

FIG. 28 shows the cam actuator 2705 after being rotated away from the cam buckle 2700 so as to no longer engage the cam buckle 2700. The lever 2510 is rotated back in the first direction in order to release the cam actuator 2705 from being in contact with the cam buckle 2700. In FIG. 28, the lever 2510 is rotated counter-clockwise in order to take slack out of the system, such as via a one-way ratchet. Rotating the lever 2510 counter-clockwise to ratchet the cam actuator 2705, operates in a fashion similar to a retractable ratchet strap. When the cam actuator 2705 is no longer pressing against the cam buckle 2700, the cam buckle 2700 prevents the harness adjuster strap 205 from moving through the cam buckle 2700. Rotating the lever 2510 in the second direction therefore prevents the slack of the harness adjuster strap 205 within the system from being adjusted.

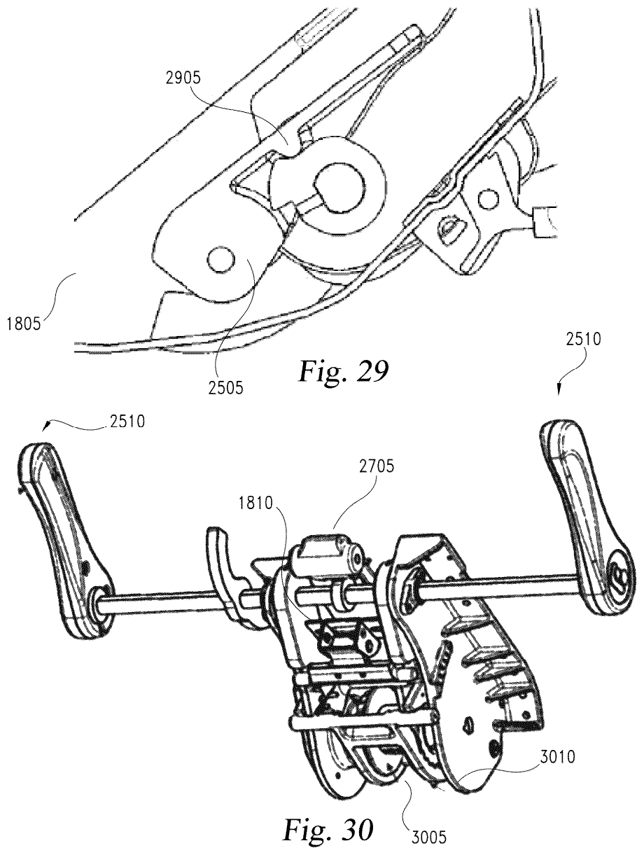

FIG. 29 shows a zoomed-in view of the lever locking feature 2710 feature. In FIG. 29, the lever locking feature 2710 is engaged against the lever 2510 to prevent the lever 2510 from being activated. The lever locking feature 2710 feature prevents a child or another passenger from activating the lever locking feature 2710. The lever locking feature 2710 is placed between the lever 2510 and the seat bottom 130. The lever locking feature 2710 abuts one side of the lever 2510. In FIG. 29. the lever locking feature 2710 is prevented from rotating counter-clockwise but the lever locking feature 2710 does not prevent the lever 2510 from rotating clockwise.

FIG. 30 shows a perspective view of the handle harness adjuster 105 according to one example. The cam actuator 2705 of the handle harness adjuster 105 is located between the handle harness adjuster 105 and the seat bottom 130. The cam actuator 1805 of the handle harness adjuster 105 is facing the seatback 125. As can be seen in FIG. 30, the handle harness adjuster 105 has more than one child safety seat 2500. The child safety seat 2500 is located on both lateral planes of the child safety seat 100. Placing a child safety seat 2500 on either side of the child safety seat 100 allows a user or passenger to access the child safety seat 2500 with either hand. The child safety seat 2500 on either side of the child safety seat 100 are operatively connected to one another such that the child safety seat 2500 on either side of the child safety seat 100 cannot work against one another. The cam actuator 2705 includes a spool 3005 and a slip clutch 3010. Placing the spool 3005 and the slip clutch 3010 in two separate locations provides further assurance.

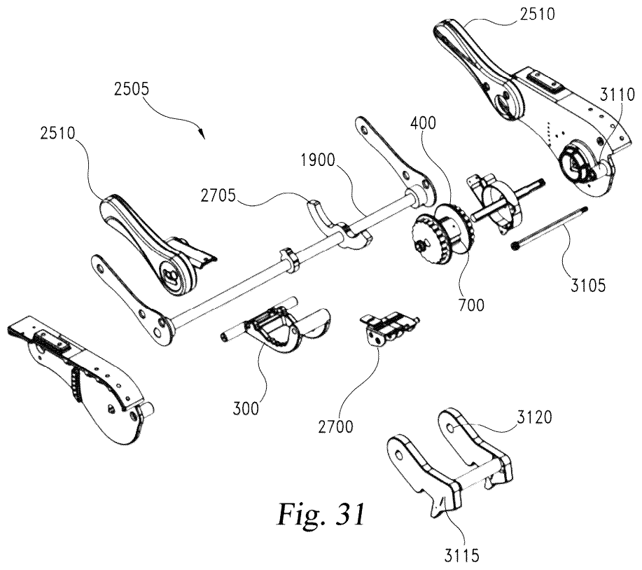

FIG. 31 is an exploded view of the lever harness adjuster 2505. The lever harness adjuster 2505 includes two levers 2510. Generally, the two levers 2510 are located on either side of the child safety seat 2500 and/or on either side of the passenger. This permits ease of access to the lever harness adjuster 2505 from either side. The lever harness adjuster 2505 includes a shaft 1900 which facilitates transferring movement of the lever 2510 to the remainder of the system. The lever harness adjuster 2505 also has a cam actuator 2705. rotating the lever 2510 of the lever harness adjuster 2505 causes the shaft 1900 to rotate. Rotating the shaft 1900 causes the cam actuator 2705 to contact the cam buckle 2700.

The lever harness adjuster 2505 also includes a connection pin 3105 operatively connected to the lever harness adjuster 2505. The connection pin 3105 acts to keep the lever harness adjuster 2505 in proper place. The connection pin 3105 is configured to connect to a connection pin receiver 3110. The lever harness adjuster 2505 also has a cam buckle housing 3115 which operates to house the cam buckle 2700. In certain configurations, the connection pin 3105 and/or the shaft 1900 pass through the cam buckle housing 3115. The cam buckle housing 3115 has a connection pin hole 3120 to receive the shaft 1900. The connection amongst the shaft 1900, the cam buckle housing 3115, and the connection pin 3105 act to keep the lever harness adjuster 2505 in proper alignment.

### Glossary of Terms

The language used in the claims and specification is to only have its plain and ordinary meaning, except as explicitly defined below. The words in these definitions are to only have their plain and ordinary meaning. Such plain and ordinary meaning is inclusive of all consistent dictionary definitions from the most recently published Webster's dictionaries and Random House dictionaries. As used in the specification and claims, the following definitions apply to these terms and common variations thereof identified below.

“About” with reference to numerical values generally refers to plus or minus 10% of the stated value. For example, if the stated value is 4.375, then use of the term “about 4.375” generally means a range between 3.9375 and 4.8125.

“And/Or” generally refers to a grammatical conjunction indicating that one or more of the cases it connects may occur. For instance, it can indicate that either or both of two stated cases can occur. In general, “and/or” includes any combination of the listed collection. For example, “X, Y, and/or Z” encompasses: any one letter individually (e.g., {X}, {Y}, {Z}); any combination of two of the letters (e.g., {X, Y}, {X, Z}, {Y, Z}); and all three letters (e.g., {X, Y, Z}). Such combinations may include other unlisted elements as well.

“Automatic Locking Retractor” or “ALR” generally refers to a type of retractor that provides the ability to hold a belt at a set position and/or a fixed length. The ALR locks when a continuous motion of spooling the belt out has stopped. Once the belt is pulled into place, the ALR allows the extra belt webbing to retract back into the ALR until the belt is tight and all slack in the belt is removed. At this point, the ALR prevents the belt from being released or pulled from the ALR. In one configuration, the ALR has a bar that locks into gears of a spool around which the belt is wrapped. Once the ALR locks the belt place, the belt generally cannot be withdrawn from the retractor. The ALR can be used in a wide variety of environments. For instance, the ALR can be used for adult seat belts or for securing child seats.

“Axis” generally refers to a straight line about which a body, object, and/or a geometric figure rotates or may be conceived to rotate.

“Belt” generally refers to a narrow, flexible strip or band of material such as in the form of webbing or straps. The belt can be made of a unitary piece of material in some examples. In other examples, the belt can be made from multiple materials such as woven strands or wires found in webbing for seat belt systems.

“Belt Adjuster” generally refers to a belt, strap, and/or webbing adjustment mechanism that releases the hold of the mechanism on the belt for the purpose of releasing tension and/or lengthening the belt when actuated. Typically, but not always, the belt adjuster does not inhibit the belt from being shortened when the free end of the belt is pulled.

“Buckle” generally refers to device, such as in the form of a clasp, that releasably secures two or more loose ends together. Typically, but not always one end is secured to or otherwise attached to the clasp device, and the other end is releasably or adjustably held by the clasp device. The ends can be for a variety of objects such as straps, belts, cables, and webbing, to name just a few. One common type of buckle is a seat belt buckle found in a wide variety of vehicles. For instance, the buckle can be used in two-point, three-point, four-point, five-point, or six-point harness systems. In one example, the loose end of a seat belt is looped through a slot in a latch plate that includes a tongue, and to secure the loose end, the tongue is inserted into a seat belt buckle that is attached to a fixed seat belt or webbing.

“Cam Buckle” generally refers a device or mechanism that includes a frame and a cam (or jaw) pivotally coupled to the frame configured to lock a belt or webbing at a fixed position and/or length. The cam commonly, but not always, includes a lever or handle to allow a user to rotate the cam. The cam can be pivotally mounted to the frame in a number of ways such as through one or more pins and/or a shaft. In one use case example, a free end of the belt passes through a clearance or gap between the frame and the cam. When the cam is rotated relative to the frame, the size of the clearance gap between the cam and frame changes. For instance, rotating the cam in one direction reduces the clearance gap, and rotating the cam in the opposite direction increases the clearance gap. As an example, when the cam is rotated to a closed or locked position, the clearance gap between the cam and the frame is reduced such that the cam bites against the belt to clamp the belt between the cam and frame. In some designs, the cam has a knurled or serrated gripping surface configured to bite against the belt, and in other designs, the gripping surface can be generally smooth or have other types of textures. As tension is applied to the belt, the cam is configured to further rotate which in turn reduces the clearance so as to increasing the biting force applied by the cam against the belt. To release the belt, the cam is rotated in the opposite to an opened or unlocked (released) position, the clearance gap between the cam and the frame increases to such a point where the cam no longer grips or bite into the belt. When the cam is in the opened position, the belt is able to slide relative to the cam buckle such that the belt can even be removed from the cam buckle. In some design configurations, the cam buckle further includes a spring or other biasing device that biases the cam to either the opened or closed position. In one design variation, the spring is coupled between the cam and frame so as to bias the cam to the closed position where the belt is locked in place. In such a case, the user presses against or otherwise actuates the lever of the cam to release the belt. The cam buckle can be made from a variety of materials such as metal and/or plastic, and the cam buckle can come in a variety of shapes, sizes, and types. Cam buckles can be used in a large number of ways such as for securing equipment, child safety seats, or even belts for clothing. For example, one type of cam buckle for child restraint systems is sold under the brand A-LOK® by Indiana Mills & Manufacturing, Inc. (IMMI).

“Child Safety Seat”, “Car Seat”, or “Child Restraint System” generally refer to a seat that is specifically designed to protect children from injury during a vehicle collision. Commonly, the child safety seat is an aftermarket product that is installed by an owner into a vehicle after purchase of the vehicle, but the child safety seat can be also integrated into a seat of the vehicle by a manufacturer of the vehicle. In contrast to most vehicle seats, which are designed to accommodate adults, the child safety seat is sized and configured to properly position a child or infant to reduce injury during an accident. The child safety seat further typically includes a passive restraint system, such as a harness, that generally holds an occupant of the seat in place during a collision. The restraint system for example can include a five-point harness, but other types of harnesses and restraints can be used. When sold as a separate, aftermarket product, the child safety seat can include an anchoring mechanism, like an Isofix connecter, configured to secure the child safety seat to the vehicle (e.g., via an Isofix anchor in the vehicle). Some typical types of child safety seats include infant seats, convertible seats, combination seats, and booster seats, just to name a few.

“Clutch” generally refers to a device that engages and disengages mechanical power transmission between two or more rotating shafts or other moving components. While the motions involved are usually rotary motions, linear clutches are also used to engage and disengage components moving with a linear or near linear motion. The clutch components can for instance be engaged and disengaged through mechanical, hydraulic, and/or electrical actuation. The clutches can include positive type clutches and friction type clutches. Wet type clutches are typically immersed in a cooling lubrication liquid or other fluid, and dry clutches are not bathed in such liquids. Some non-limiting examples of clutches include cone clutches, centrifugal clutches, torque limiter clutches, axial clutches, disc clutches, dog clutches, and rim clutches, to name just a few.

“Emergency Locking Retractor” or “ELR” generally refers to a type of retractor that holds a belt in a fixed position or length only in response to rapid deceleration/acceleration and/or rapid spooling out of the belt from the retractor. For instance, the belt is typically stowed on a spring-loaded reel or spool equipped with inertial locking mechanisms that stop the belt from extending off the reel during severe deceleration. There are generally two main types of ELRs. A belt-sensitive locking retractor is based on a centrifugal clutch activated by the rapid acceleration of the belt from the reel. The belt can be pulled from the reel only slowly and gradually, and an sudden rapid pulling of the belt, such as during a collision, causes the reel to lock. A vehicle-sensitive locking retractor type locks the belt when a pendulum swings away from a plumb position during rapid deceleration of the vehicle. In the absence of rapid deceleration or rollover, the reel is unlocked and the belt is able to be pulled from the reel against the spring tension of the reel. The vehicle occupant can move around with relative freedom while the spring tension of the reel keeps the belt taut against the occupant. When the pendulum swings away from a normal plumb position due to sudden deceleration or rollover, a pawl is engaged, the reel locks the belt. Dual-sensing locking retractors use both the belt-sensitive and vehicle-sensitive techniques to initiate the locking mechanism. The ELR is designed to increases the comfort of belt during routine use. For instance, the ELR is designed to allow the belt to move freely once the belt is in place, but the ELR locks the belt instantly in the event of rapid acceleration or deceleration such as occurring during a crash or other collision. In one use case, the locking sensitivity of the ELR assures that the ELR locks very early during the collision, but the ELR is not so sensitive as to cause nuisance locking during normal use conditions. Generally, there are two types of ELR sensitivity factors, the sensitivity to the belt withdrawal rate and the sensitivity to deceleration/acceleration. In one design example, the ELR for responds directly to a 0.7 g acceleration pulse and lock-up of the belt usually occurs within a short period of time. Some seat belt and child car seat designs incorporate an ELR. For instance, when a belt is worn properly and without slack, the ELR will restrain a occupant correctly during a rapid deceleration of a vehicle.

“Fastener” generally refers to a hardware device that mechanically joins or otherwise affixes two or more objects together. By way of non-limiting examples, the fastener can include bolts, dowels, nails, nuts, pegs, pins, rivets, screws, buttons, hook and loop fasteners, and snap fasteners, to just name a few.

“Five-Point Harness” generally refers to a restraint system that includes five straps or web portions that are mounted to a seat. Two of the straps are typically located to secure at the shoulders of an occupant of the seat, and another two of the straps are typically located proximal the hips of the occupant when seated. One of the straps is located at the crotch of the occupant when seated in the seat, and this strap typically includes a releasable buckle or other similar mechanism that releasable secures the five straps together so as to secure the occupant in the seat. The straps can be tightened or loosened depending on the size of the occupant and/or whether the occupant is being secured or removed from the seat. Five-point harnesses can be for example integrated into race car seats or child safety seats.

“Handle” generally refers to a part that is designed especially to be grasped by a human hand. In other words, a handle is a part by which an object, such as a tool or device, is held, carried, and/or controlled by a human hand. A handle typically has sufficient strength to support the object. For tools, the handle typically has sufficient strength to transmit any force from the handle to perform the designed functionality for the tool. The handle usually has a sufficient length to accommodate a single hand or multiple hands to grip and reliably exert force through the handle. Similarly, the handle commonly has a sufficiently small circumference or exterior size to permit single hand or multiple hands to reliably grip the handle. Other ergonomic factors, such friction, coating, grip, and injury prevention features, can be incorporated into the handle. By way of non-limiting examples, the handles can include broom handles, shovel handles, pull handles, or twist handles, to name just a few.

“Harness” generally refers to a set of straps and fittings for fastening a human or other animal in a particular place and/or position. The straps can come on many forms, such as belts, webbing, or ropes, and the straps can be made of a variety of materials such as natural or synthetic materials. The fittings are designed in a variety of forms for securing the straps around the individual as well as releasing the straps to free the individual. The harness can include webbing, buckles, latch plates, and/or length-adjustment mechanisms, such as a retractor. In one example, the fitting includes a set of latch plates that are secured in a buckle release mechanism. Harnesses can for instance be integrated into vehicle seats, child booster seats, and child safety seats. The straps and fitting can be configured in a number of manners such as to form three-point, five-point, and six-point harnesses, to name just a few examples.

“Harness Adjuster” generally refers to a device used to tighten and loosen a harness. The harness adjuster can be used to tighten a wide variety of harnesses, such as those used in vehicles. Commonly the harness adjusters are used in child safety seats, but the harness adjuster can have other use cases like for harnesses that secure adults. The harness adjuster can be located at a variety of locations. For instance, the harness adjuster can be located on the back of the seat, on the side of the seat, on the harness itself, and/or between the legs of a seat occupant. In some designs, the harness adjuster is coupled to the harness through a harness adjuster belt or strap and a splitter plate coupled to the harness adjuster belt. One end of the harness adjuster belt is generally engaged with the harness adjuster and the opposite end is coupled to the splitter plate. The splitter plate in one version is in turn coupled to one or more shoulder belts (e.g., two shoulder belts) of the harness.

“Harness Adjuster Strap” or “Harness Adjuster Belt” generally refers to a single piece of belt or webbing used to tighten a harness. In one common design, the harness adjuster strap is coupled to a harness adjuster configured to loosen or tighten the harness adjuster strap. In this design, the other end of the harness adjuster strap is coupled to a splitter plate which in turn is coupled to one or more belts of the harness.

“Helical Spring” or “Coil Spring” generally refers to a type of spring that is formed in the shape of a helix and that returns to an initial length of the spring when unloaded. Typically, but not always, the helical springs are made of elastic material like metal and/or plastic. For example, helical springs can include tension, compression, and torsion springs, to name just a few.

“Latch Plate” generally refers to a part of a vehicle belt assembly that releasably connects to a buckle and through which the belt or webbing is threaded or otherwise secured. Typically, but not always, the latch plate is in at least part made of metal and/or plastic. The latch plate includes one or more tongues that are inserted into the buckle. Each tongue can include a notch or other opening that is used to secure the latch plate to the buckle. By way of non-limiting examples, the latch plates can include free-sliding latch plates, cinching latch plates, locking latch plates, and switchable latch plates, to name just a few examples.

“Lever” generally refers to a simple machine including a beam, rod, or other structure pivoted at a fulcrum, such as a hinge. In one form, the lever is a rigid body capable of rotating on a point on itself. Levers can be generally categorized into three types of classes based on the location of fulcrum, load, and/or effort. In a class 1 type of lever, the fulcrum is located in the middle such that the effort is applied on one side of the fulcrum and the resistance or load on the other side. For class 1 type levers, the mechanical advantage may be greater than, less than, or equal to 1. Some non-limiting examples of class 1 type levers include seesaws, crowbars, and a pair of scissors. In a class 2 type of lever, which is sometimes referred to as a force multiplier lever, the resistance or load is located generally near the middle of the lever such that the effort is applied on one side of the resistance and the fulcrum is located on the other side. For class 2 type levers, the load arm is smaller than the effort arm, and the mechanical advantage is typically greater than 1. Some non-limiting examples of class 2 type levers include wheelbarrows, nutcrackers, bottle openers, and automobile brake pedals. In a class 3 type lever, which is sometimes referred to as a speed multiplier lever, the effort is generally located near the middle of the lever such that the resistance or load is on one side of the effort and the fulcrum is located on the other side. For class 3 type levers, the effort arm is smaller than the load arm, and the mechanical advantage is typically less than 1. Some non-limiting examples of class 3 type levers include a pair of tweezers and the human mandible.

“Positive Lock” generally refers to a type fastening structure that is configured to remain secured even under vibratory or other loads.

“Ratchet” generally refers to a mechanical device that allows linear or rotary motion in only one direction while preventing motion in the opposite direction. Typical ratchets include of a round gear or a linear rack with teeth, and a pivoting, spring-loaded finger or pawl that engages the teeth. The teeth are normally uniform but have an asymmetrical shape. Each tooth typically has a moderate slope on one edge and a much steeper slope on the other edge. When the teeth are moving in the unrestricted direction, the pawl easily slides over the gently sloped edges of the teeth. The spring of the pawl pushes the pawl into the depression between the teeth as the pawl passes the tip of each tooth. When the teeth move in the opposite direction, the pawl catches against the steeply sloped edge of one of the teeth so as to lock the pawl against the tooth and prevent any further motion in that direction. Ratchets in some devices, such as socket wrenches, can be reversible such that the locking direction can be switched (e.g., reversed).

“Ratchet Strap” or “Tie Down Strap” is device or assembly that include a belt or webbing and hardware (or fastener) that removes slack and/or applies tension to the webbing through a ratchet type action. Once the webbing is threaded through, the ratchet hardware or mechanism is employed to take up the slack and tension the webbing to the necessary level. The ratchet mechanism functions in a fashion similar to a socket wrench. The ratchet mechanism in some versions includes a handle, lever, or arm that is reciprocated (e.g., repeatedly opened and closed) to pull the webbing through the mechanism. The ratchet strap can further employ a release lever or button to release tension in the webbing. For instances, the release lever can be depressed to release the tension, and the webbing can then be pulled back through the hardware.

“Retractable Ratchet Strap” or “Retractable Ratchet Tie Down” generally refers to a type a ratchet strap that further includes a retractor configured to spool slack in the belts or webbing so that the webbing can be automatically retracted. In one version, the hardware includes a spring biased spool or reel around which the webbing is wrapped. The reel is usually biased by a coil or helical spring, but other types of springs and biasing devices are used in other examples. The reel typically includes gear teeth that are engaged by a spring biased pawl or other structure so that the reel normally is only able to rotate in one direction (e.g., for pulling out the webbing). A lever, button, and/or handle can be actuated so as to release the pawl from engagement with the gear teeth. This in turn causes spring biased reel to spool the webbing back into a housing or compartment so as to alleviate slack.

“Retractor” generally refers to a winding mechanism that spools a belt, such as seat belt webbing, to allow the belt to be withdrawn or pulled back into the retractor. The retractor typically operates in a fashion similar to a tape measure. Some retractor designs include a rotatable spool or reel around which the belt is wound and a spring such as a coil spring (or other device to store potential energy) that is coupled to the spool. When the belt is pulled from the retractor, the spring stores some of this energy as potential energy that is later used to pull the belt back into the retractor by rewinding the spool. When the belt is not in use, the retractor spools the unused length belt or slack into a compartment. Some locking retractor designs further include a locking mechanism, such as a clutch, pawl, or other device, to lock the belt in place such as during rapid deceleration. For instance, some locking retractor types can include an automatic locking retractor (ALR), an emergency locking retractor (ELR), and a switchable retractor, to name just a few examples.

“Seat Belt System” and “Safety Belt System” generally refers to an arrangement of webs, straps, and other devices designed to restrain or otherwise hold a person or other object steady such as in a boat, vehicle, aircraft, and/or spacecraft. For example, the seat belt is designed to secure an occupant of a vehicle against harmful movement that may result during a collision or a sudden stop. By way of non-limiting examples, the seat belt can include webbing, buckles, latch plates, and/or length-adjustment mechanisms, such as a retractor, installed in the vehicle that is used to restrain an occupant or a child restraint system. The seat belt for instance can include a lap belt only, a combination lap-shoulder belt, a separate lap belt, a separate shoulder belt, and/or a knee bolster.

“Seat Bottom” generally refers to the portion of a seat that a passenger sits on and the mounting structure, such as mounting pedestals, for securing the seat assembly to the vehicle.

“Splitter Plate” generally refers to a component that connects one or more belts of a harness to a harness adjuster strap. Typically, the splitter plate is made of strong material, such as metal, but the splitter plate can be made from other materials. In one version, the splitter plate is a metal piece on the back of a car seat that attaches the ends of two shoulder belts of the harness to the harness adjuster strap. In another variation, a single belt that acts as one or more shoulder straps is looped through the splitter plate.

“Spring” generally refers to an elastic object that stores mechanical energy. The spring can include a resilient device that can be pressed, pulled, and/or twisted but returns to its former shape when released. The spring can be made from resilient or elastic material such as metal and/or plastic. The spring can counter or resist loads in many forms and apply force at constant or variable levels. For example, the spring can include a tension spring, compression spring, torsion spring, constant spring, and/or variable spring. The spring can take many forms such as by being a flat spring, a machined spring, and/or a serpentine spring. By way of nonlimiting examples, the springs can include various coil springs, pocket springs, Bonnell coils, offset coils, continuous coils, cantilever springs, volute springs, hairsprings, leaf springs, V-springs, gas springs, leaf springs, torsion springs, rubber bands, spring washers, and/or wave springs, to name just a few.

“Vehicle” generally refers to a machine that transports people and/or cargo. Common vehicle types can include land-based vehicles, amphibious vehicles, watercraft, aircraft, and space craft. By way of non-limiting examples, land-based vehicles can include wagons, carts, scooters, bicycles, motorcycles, automobiles, buses, trucks, semi-trailers, trains, trolleys, and trams. Amphibious vehicles can for example include hovercraft and duck boats, and watercraft can include ships, boats, and submarines, to name just a few examples. Common forms of aircraft include airplanes, helicopters, autogiros, and balloons, and spacecraft for instance can include rockets and rocket powered aircraft. The vehicle can have numerous types of power sources. For instance, the vehicle can be powered via human propulsion, electrically powered, powered via chemical combustion, nuclear powered, and/or solar powered. The direction, velocity, and operation of the vehicle can be human controlled, autonomously controlled, and/or semi-autonomously controlled. Examples of autonomously or semi-autonomously controlled vehicles include Automated Guided Vehicles (AGVs) and drones.

“Web” or “Webbing” generally refers to a strap made of a network of thread, strings, cords, wires, and/or other materials designed to restrain or otherwise hold a person or other object steady such as in a boat, vehicle, aircraft, and/or spacecraft. By way of non-limiting examples, the web can be incorporated into a seat belt, a child booster seat, and/or a car seat.

It should be noted that the singular forms “a,” “an,” “the,” and the like as used in the description and/or the claims include the plural forms unless expressly discussed otherwise. For example, if the specification and/or claims refer to “a device” or “the device”, it includes one or more of such devices.

It should be noted that directional terms, such as “up,” “down,” “top,” “bottom,” “lateral,” “longitudinal,” “radial,” “circumferential,” “horizontal,” “vertical,” etc., are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by the following claims are desired to be protected. All publications, patents, and patent applications cited in this specification are herein incorporated by reference as if each individual publication, patent, or patent application were specifically and individually indicated to be incorporated by reference and set forth in its entirety herein.

### REFERENCE NUMBERS

100 child safety seat
101 harness adjuster
105 handle harness adjuster
110 handle
115 harness
116 buckle
117 belt
120 harness slot
125 seatback
130 seat bottom
135 activation space
140 leveraging protrusion
145 second position barrier
150 outer protrusion
155 head support
160 angled portion
170 headrest adjuster
201 splitter plate
202 spool housing
205 harness adjuster strap
210 retractor
215 biasing pin
220 cam buckle
225 cam actuator
300 ratchet-pawl mechanism
305 belt or webbing guide
310 pin
315 harness or webbing pathway
400 gear
405 gear teeth
410 clutch pawl
411 clutch pawl teeth
412 smooth portion
415 spring
500 pronged portion
505 pivot point
600 force-applying mechanism
700 spool
705 strap passage
710 rib
715 structural spacer
1100 curved finger
1100 rod
1200 curved portion
1205 spaced rivet
1300 rotate shaft
1700 child safety seat
1705 knob harness adjuster
1710 knob
1800 cam buckle
1805 cam actuator
1900 shaft
2000 push-twist activator
2005 connective arm
2010 push-twist mechanism
2015 receiving piece
2020 interlocking member
2025 pull cord
2030 second clutch
2200 shaft housing
2205 first slip clutch
2210 second slip clutch
2300 first slip clutch
2305 second slip clutch
2500 child safety seat
2505 lever harness adjuster
2510 lever
2700 cam buckle
2705 cam actuator
2710 lever locking feature
3005 spool
3010 slip clutch
3105 connection pin
3110 connection pin receiver
3115 cam buckle housing
3120 connection pin hole

What is claimed is:

1. A system, comprising:
a cam buckle;
a harness adjuster strap threaded through the cam buckle;
a harness adjuster;
wherein the harness adjuster includes a retractor;
wherein the retractor is biased to pull the harness adjuster strap into the retractor;
wherein the cam buckle has an unlocked position where the harness adjuster strap is able to slide through the cam buckle;
wherein the cam buckle has a locked position where the harness adjuster strap is locked to the cam buckle;
wherein the cam buckle is biased towards the locked position;
wherein the harness adjuster includes an actuator;
wherein the actuator is configured to engage the cam buckle to move the cam buckle to the unlocked position to release the harness adjuster strap; and
wherein the actuator is configured to disengage from the cam buckle to allow the cam buckle to return to the locked position to secure the harness adjuster strap.

2. The system of claim 1, wherein the retractor is a locking type retractor.

3. The system of claim 1, wherein:
the retractor includes a spool around which the harness adjuster strap is wrapped; and
the spool is spring biased to wrap the harness adjuster strap around the spool.

4. The system of claim 3, wherein the harness adjuster includes a ratchet.

5. The system of claim 4, wherein:
the spool has one or more gears with teeth;
the ratchet includes a pawl configured to engage the teeth of the spool; and
the pawl is configured to engage the teeth of the spool to inhibit rotation of the spool in at least one direction.

6. The system of claim 5, wherein:
the cam buckle when in the locked position is configured to allow the retractor to pull the harness adjuster strap into the retractor; and
the cam buckle when in the locked position is configured to inhibit the harness adjuster strap from being pulled from the retractor.

7. The system of claim 5, wherein the pawl is configured to pivot to disengage from the teeth of the spool to allow the spool to rotate to retract the harness adjuster strap into the retractor.

8. The system of claim 5, wherein the actuator is configured to move the cam buckle to the unlocked position and disengage the pawl from the teeth of the spool to retract the harness adjuster strap into the retractor.

9. The system of claim 8, wherein the actuator is configured to move the cam buckle to the locked position and engage the pawl with the teeth of the spool to further retract the harness adjuster strap into the retractor.

10. The system of claim 5, wherein the pawl is configured to slip from the teeth when a set force is applied.

11. The system of claim 5, further comprising:
a harness;
wherein the harness adjuster strap is coupled to the harness; and
wherein the cam buckle when in the locked position is configured to inhibit loosening of the harness.

12. The system of claim 11, wherein the pawl is configured to disengage from the teeth of the spool to allow rotation of the spool for tightening the harness.

13. The system of claim 1, wherein the actuator includes a handle.

14. The system of claim 13, further comprising:
a child safety seat;
wherein the child safety seat has a seat bottom; and
wherein the handle is located at a central location on the seat bottom.

15. The system of claim 1, wherein the actuator includes a knob.

16. The system of claim 15, further comprising:
a child safety seat; and
wherein the knob is disposed along a lateral side of the child safety seat.

17. The system of claim 15, wherein the knob is configured to facilitate push-twist activation.

18. The system of claim 1, wherein the actuator includes a lever.

19. The system of claim 18, further comprising:
a child safety seat; and
wherein the lever is disposed along a lateral side of the child safety seat.

20. The system of claim 1, wherein:
the retractor is biased to pull the harness adjuster strap into the retractor;
the cam buckle has an unlocked position where the harness adjuster strap is able to slide through the cam buckle;
the cam buckle has a locked position;
the cam buckle when in the locked position is configured to allow the retractor to pull the harness adjuster strap into the retractor;
the cam buckle when in the locked position is configured to inhibit the harness adjuster strap from being pulled from the retractor;
the cam buckle is biased towards the locked position;
the actuator includes a pin configured to guide the harness adjuster strap;
the actuator is actuatable from a first position to a second position;
the harness adjuster strap wraps around the pin to form a serpentine path when the actuator moves from the first position to the second position; and
the retractor is configured to pull into the retractor slack created in the harness adjuster strap by the serpentine path when the actuator moves from the second position to the first position.
